(19) United States
(12) Patent Application Publication
(10) Pub. No.: US 2012/0284132 A1
(43) Pub. Date: Nov. 8, 2012

(54) DISPLAY DEVICE ATTACHABLE TO SHOPPING CARTS, SHOPPING CART, AND DIGITAL SIGNAGE DISPLAY

(76) Inventors: Uniyoung Kim, Seoul (KR); Hyungnam Lee, Seoul (KR); Gangseub Lee, Seoul (KR); Saehun Jang, Seoul (KR); Jaekwon Shim, Seoul (KR); Yuntae Jung, Seoul (KR); Jaekwang Bahn, Seoul (KR)

(21) Appl. No.: 13/449,127

(22) Filed: Apr. 17, 2012

(30) Foreign Application Priority Data
May 3, 2011 (KR) 10-2011-0041949
May 3, 2011 (KR) 10-2011-0041950

(51) Int. Cl. G06Q 20/18; G06F 17/30

(52) U.S. Cl. 705/20; 235/375

(57) ABSTRACT

A display device attachable to a shopping cart, and including a communication module configured to receive information on a specific product from a digital device displaying at least one or more products; a code reader configured to read code information attached to a random product selected from the at least one or more products; a display module; and a controller configured to compare the code information of a product recognized by the code reader with the received information on the specific product, and to control the display module to either display a guide message that the compared code information and the received information are identical or a guide message indicating the compared code information and the received information are not identical.

Pursuant to 35 U.S.C. §119(a), this application claims the benefit of earlier filing date and right of priority to Korean Patent Application Nos. 10-2011-0041949, filed on May 3, 2011, and 10-2011-0041950, filed on May 3, 2011, the contents of which are hereby incorporated by reference herein in their entirety.

### BACKGROUND OF THE INVENTION

1. Field of the Invention

The present invention relates to digital devices used in supermarkets and, more particularly, to a display device attachable to shopping carts, a shopping cart, and a digital signage display. Herein, for example, a supermarket refers to a commercial location wherein at least one or more carts, in which products or items may be loaded, can move around dynamically.

2. Discussion of the Related Art

Generally, there exist two different methods for purchasing one or more specific products. One method corresponds to having a purchaser (i.e., user) access an on-line store over the internet, fill out a purchase order for one or more specific products selected by the purchaser, so that the purchaser can receive the purchased products) after a predetermined period of time. Additionally, another method corresponds to having a purchaser visit a traditional marketplace (or street market) and purchase one or more specific products selected by the purchaser, thereby immediately acquiring the purchased items.

More particularly, the second method may be advantageous in that the purchaser can verify the actual products in person, select one or more wanted products, load the selected products in his (or her) shopping cart, thereby purchasing the selected products.

However, in the related art supermarket environment, analog shopping carts are used, and the final payment process for the selected products is each carried out (or performed) and processed by a large number of employees employed by the owner of the corresponding supermarket. Therefore, a solution for accelerating the payment process for the purchased items as compared to the conventional method currently used in supermarkets, and a solution for preventing theft during the payment process are being required.

### SUMMARY OF THE INVENTION

Accordingly, the present invention is directed to a display device attachable to shopping carts, a shopping cart, and a digital signage display that substantially obviate one or more problems due to limitations and disadvantages of the related art.

An object of the present invention is to define a communication protocol between a digital device displaying the products located in the supermarket and a display device mounted on shopping carts of a supermarket.

Another object of the present invention is to provide a digital system that can prevent products or items located (or displayed) in each aisle of the corresponding supermarket from being lost or stolen.

A further object of the present invention is to define and provide a communication method of a digital signage display and a user interface that can replace the large number of employees working in the corresponding supermarket, thereby minimizing the payment process.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a display device attachable to a shopping cart includes a communication module configured to receive information on a specific product from a digital device displaying at least one or more products, a code reader configured to recognize code information attached to a random product, a comparison module configured to compare the code information of a product recognized by the code reader with information on the received information on the specific product, a controller configured to generate a first control signal, when it is determined that the information are identical, and to generate a second control signal, when it is determined that the information are not identical, and a display module configured to display a guidance message based upon any one of the control signals generated by the controller.

According to another aspect of the present invention, a method for controlling a digital signage display located in a supermarket includes detecting a specific shopping cart being equipped with a code reader, a memory, and a communication module, controlling the digital signage display so that communication can be performed between the detected specific cart and the digital signage display, receiving first information and second information, both information being stored in a memory of the specific cart, wherein the first information corresponds to unique ID data being assigned in order to enable the shopping cart to be identified among a plurality of other shopping carts existing in the supermarket, and wherein the second information corresponds to data indicating whether or not payment process for products loaded in the shopping cart can be performed, displaying a first message providing a user with guidance for performing the payment process respective to the products loaded in the shopping cart, when the second information indicates that the payment process can be performed, and displaying a second message informing the user that the payment process respective to the products loaded in the shopping cart cannot be performed, when the second information indicates that the payment process cannot be performed.

According to yet another aspect of the present invention, a method for controlling a server managing a plurality of devices located in a supermarket includes receiving information on at least one or more products from a wireless module of a display device equipped to a shopping cart, in real time, wherein the information of at least one or more products is mapped to a first ID information for identifying a specific cart, storing the received information on the at least one or more products in a database along with the first ID information, receiving a request signal requesting price information corresponding to a specific shopping cart from a digital signage display, wherein the request signal includes a second ID information identifying the digital signage display, accessing the database and calculating a total price information for the at least one or more products loaded in the shopping cart, and transmitting the total price information to a digital signage display corresponding to the second ID information.

In a further aspect of the present invention, a recording medium readable by a computer, the computer having data for executing the method of the present invention recorded in the recording medium.

It is to be understood that both the foregoing general description and the following detailed description of the present invention are and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a general view illustrating an overall system including a shopping cart, a digital signage display, and a server according to an embodiment of the present invention;

FIG. 2 is a detailed flow chart showing data being transmitted to and from each component shown in FIG. 1;

FIG. 3 is a general view showing the outside features of a shopping cart according to an embodiment of the present invention;

FIG. 4 is a detailed block view showing an inner configuration module of the shopping cart according to an embodiment of the present invention;

FIG. 5 is a first solution for monitoring a product that is being illegitimately (or improperly) loaded in a shopping cart according to an embodiment of the present invention;

FIG. 6 is a second solution for monitoring a product that is being illegitimately (or improperly) loaded in a shopping cart according to an embodiment of the present invention;

FIG. 7 is a flow chart showing a method for monitoring a product that is being illegitimately (or improperly) loaded in a shopping cart according to an embodiment of the present invention;

FIG. 8 illustrates a method performed by a digital signage display for recognizing a single shopping cart and a user interface according to an embodiment of the present invention;

FIG. 9 illustrates a method performed by a digital signage display for recognizing multiple shopping carts and a user interface according to an embodiment of the present invention;

FIG. 10 illustrates a method performed by a digital signage display for recognizing multiple shopping carts and a user interface according to another embodiment of the present invention;

FIG. 11 illustrates a method performed by a digital signage display for automatically recognizing and processing purchased and paid products according to an embodiment of the present invention by the respective time order;

FIG. 12 illustrates a method performed by a digital signage display for automatically recognizing and processing purchased and paid products according to another embodiment of the present invention by the respective time order;

FIG. 13 illustrates a method performed by a digital signage display for automatically recognizing and processing purchased and paid products according to yet another embodiment of the present invention by the respective time order;

FIG. 14 illustrates a supplementary example of the digital signage display displaying information on an erroneous object shown in FIG. 12;

FIG. 15 illustrates a supplementary description of FIG. 14;

FIG. 16 illustrates a general view of an overall system including a shopping cart, a digital signage display, and a server according to an embodiment of the present invention;

FIG. 17 illustrates a detailed view showing the outside features of a shopping cart according to an embodiment of the present invention;

FIG. 18 illustrates a detailed block view showing an inner configuration module of a display device attachable to a shopping cart according to an embodiment of the present invention;

FIG. 19 illustrates a general view showing a communication status between a shopping cart and a digital device according to an embodiment of the present invention;

FIG. 20 illustrates a detailed flow chart showing the process of a protocol for data transmission between a shopping cart and a digital device according to an embodiment of the present invention;

FIG. 21 illustrates a detailed flow chart showing the process of a protocol for data transmission between a shopping cart and a digital device according to another embodiment of the present invention;

FIG. 22 illustrates an example of a user interface provided by the shopping cart shown in FIG. 21;

FIG. 23 is a detailed flow chart showing the processing of a protocol for data transmission between a shopping cart and a digital device according to yet another embodiment of the present invention;

FIG. 24 illustrates an example of a user interface provided by the shopping cart shown in FIG. 23;

FIG. 25 illustrates an example of a user interface output from the display module shown in FIG. 18;

FIG. 26 is a detailed flow chart showing the process a protocol for data transmission between a shopping cart and a server according to an embodiment of the present invention;

FIG. 27 illustrates an process of a display device attached to a shopping cart for controlling motions of the shopping cart according to an embodiment of the present invention;

FIG. 28 illustrates a general view showing a communication status between a shopping cart and a digital signage display according to an embodiment of the present invention; and

FIG. 29 illustrates a detailed flow chart showing the process of a protocol for data transmission between a shopping cart and a digital signage display according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The suffixes “module” and “unit” that are mentioned in the elements used to describe the present invention are merely examples used for the purpose of simplifying the description of the present invention. Therefore, the suffixes “module” and “unit” may also be alternately used for the reference of a specific element of the present invention.

Reference will now be made in detail to the preferred embodiments of the present invention, examples of which are illustrated in the accompanying drawings. However, the embodiment of the present invention described below may be modified to a wide range of modifications. In addition, therefore, it should be understood that the present invention is not be limited only to the example presented in the description of the present invention set forth herein.

Although the terms used in the present invention are selected from generally known and used terms, the terms used herein may be varied or modified in accordance with the intentions or practice of anyone skilled in the art, or along with the advent of a new technology. Alternatively, in some particular cases, some of the terms mentioned in the description of the present invention may be selected by the applicant at his or her discretion, the detailed meanings of which are described in relevant parts of the description herein. Furthermore, it is required that the present invention is understood not simply by the actual terms used but by the meaning of each term lying within.

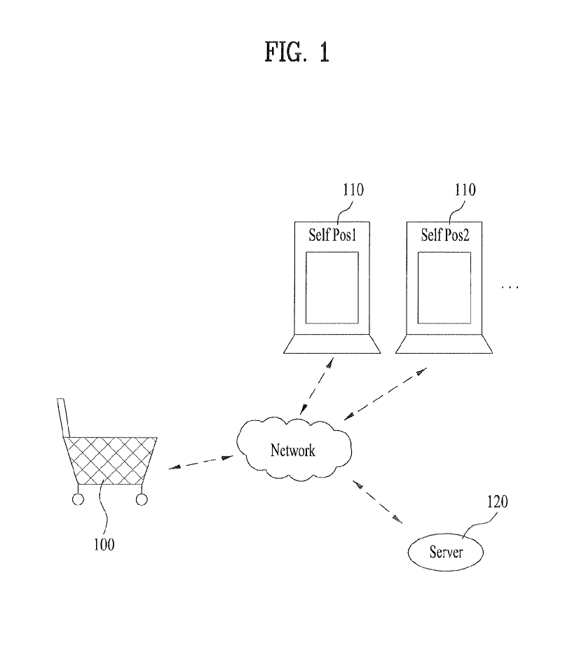

FIG. 1 illustrates a general view of an overall system including a shopping cart, a digital signage display, and a server according to an embodiment of the present invention. Hereinafter, an overall system including a shopping cart, a digital signage display, and a server according to the embodiment of the present invention will now be described in detail with reference to FIG. 1. However, it will be apparent that the elements (or components) shown in FIG. 1 are merely exemplary. Therefore, the present invention is not limited only to the elements shown in FIG. 1.

Referring to FIG. 1, at least one or more shopping carts 100 and at least one or more digital signage displays (also referred to as “digital signage”) 110 are positioned in a supermarket. In addition, for example, a server 120 may be controlled by a subject managing the supermarket.

Also, as shown in FIG. 1, each shopping cart 100, each digital signage display 110 and the server 120 are connected to one common network. Accordingly, random data may be transmitted and received to and from one another via two-way data communication. Also, according to another embodiment of the present invention, the system may be configured so that the shopping carts 100 and the digital signage display 110 can be connected through a first network, the digital signage display 110 so that the server 120 can be connected through a second network, and so that the server 120 and the shopping carts 100 can be connected through a third network.

Meanwhile, according to the embodiment of the present invention, the digital signage display 110 corresponds to a solution that is newly developed in order to enhance point-of-sales (POS) terminals provided in the related art supermarket environments. Thus, the digital signage technology may resolve the problem of wasting resource, which is caused by payment processes performed by supermarket employees using the POS terminals. The method for controlling digital signage display 110 will be described later on in more detail with reference to FIG. 8 to FIG. 15.

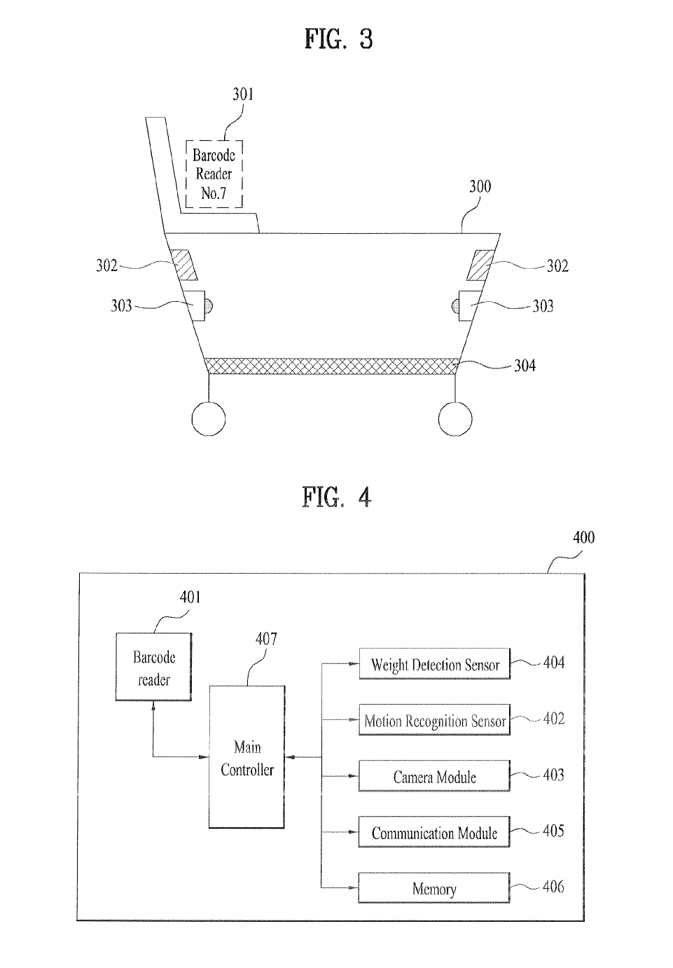

Furthermore, the shopping carts 100 according to the embodiment of the present invention may also be equipped with a holder and a monitoring module that may only detect items that are illegitimately (or improperly) loaded in the shopping cart 100. The modules included in the shopping cart 100 according to the present invention will be described in detail later on with reference to FIG. 3 to FIG. 7.

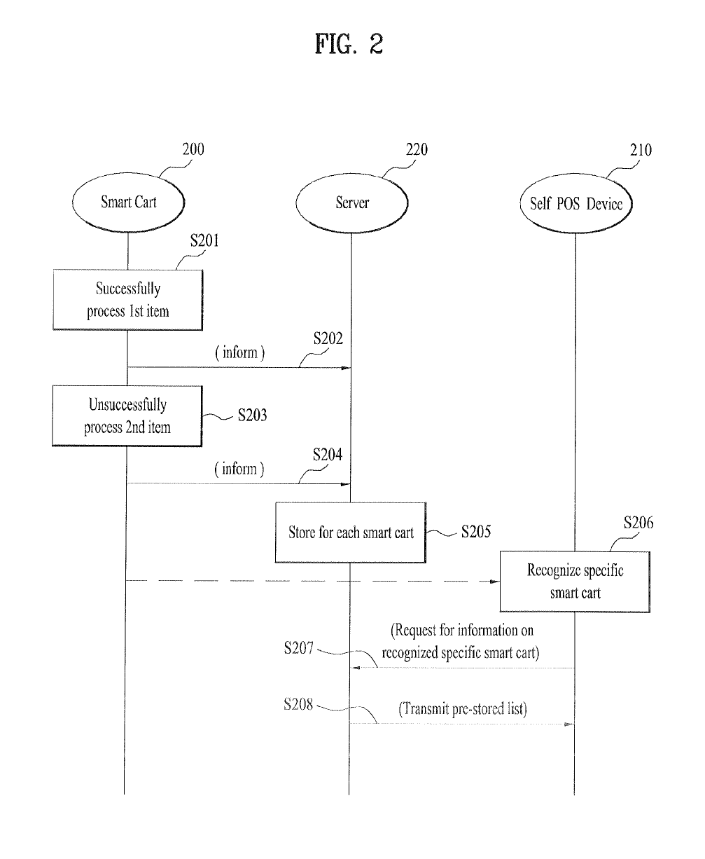

FIG. 2 is a detailed flow chart showing the process of data being transmitted to and from each component shown in FIG. 1. Hereinafter, the data that are being transmitted to and from the shopping cart and the digital signage display, shown in FIG. 1, will be described in detail with reference to FIG. 2. The shopping cart shown in FIG. 1 corresponds to a smart cart 200 shown in FIG. 2. The server shown in FIG. 1 corresponds to a server 220 shown in FIG. 2, and the digital signage display shown in FIG. 1 corresponds to a self POS device 210 shown in FIG. 2.

The smart cart 200 shown in FIG. 2 is equipped with a barcode reader and a monitoring module. A detailed illustration of the configuration modules of the above-described smart cart 200 is shown in FIG. 4.

When a 1^{st} item located in the supermarket is successfully (or normally) processed by the barcode reader of the smart cart 200 (S201), data notifying that the 1^{st} item has been successfully processed by the barcode reader are transmitted to the server 220 (S202).

Conversely, when a 2^{nd} item located in the supermarket is unsuccessfully (or abnormally) processed by the barcode reader of the smart cart 200 (S203), data notifying that the 2^{nd} item has been unsuccessfully processed by the barcode reader are transmitted to the server 220 (S204).

The server 220 uses the data received in step S202 and step S204 so as to differentiate the successfully processed items from the unsuccessfully processed items for each smart cart, thereby storing the differentiated items (S205). Also, the scope of the present invention may also include designing the smart cart so that each smart cart can be identified based upon identifier (ID) information of the barcode reader, which is attached to each smart cart.

Furthermore, in the supermarket, when a smart cart 200 carrying a plurality of items approaches a self POS device 210, the self POS device 210 recognizes the specific smart cart 200 that is approaching the self POS device 210 (S206). At this point, the self POS device 210 and the smart 200 may each be equipped with a network module enabling the self POS device 210 and the smart cart 200 to perform Wi-Fi communication or Bluetooth communication.

After recognizing the specific smart cart 200, the self POS device 210 requests for information on the specific smart cart to the server 220 (S207).

Subsequently, the self POS device 210 receives information on the items loaded in (or carried by) the specific smart cart from the server (S208). As described above in step S205, the information received in 5208 may include both the information on the items that are successfully (or normally) processed by the barcode reader and the information on the items that are unsuccessfully (or abnormally) processed by the barcode reader. Furthermore, according to another embodiment of the present invention, the information on the items that are unsuccessfully processed by the barcode reader may include image data captured (or taken) by a camera equipped in the smart cart.

Next, FIG. 3 is a general view showing the outside features of a shopping cart according to an embodiment of the present invention. Hereinafter, the general outside features of a shopping cart according to the embodiment of the present invention will be described with reference to FIG. 3. However, it will be apparent that the components shown in FIG. 3 are merely examples and that the scope of the present is not limited only to the examples shown in FIG. 3. The scope of the present invention may include designing the embodiment of the present invention by deleting some of the components shown in FIG. 3 or by adding new components that are not shown in FIG. 3.

As shown in FIG. 3, the shopping cart 300 according to the embodiment of the present invention may include a holder for a barcode reader 301, a motion recognition sensor 302, and a camera module 303. More specifically, the barcode reader 301 is configured to read barcodes marked on each item displayed in the supermarket and, more particularly, the barcodes marked on at least one or more items loaded in the shopping cart 300. The motion recognition sensor 302 is capable of detecting when a product (or item) that has failed to be read by the barcode reader is loaded in the shopping cart 300. And, the camera module 303 captures the moment when such case is detected. Also, the barcode reader 301 displays a unique identification number (e.g., Number 7 (or No. 7)) on an area of its external surface and stores the respective information in a memory. The stored information may be used as information for identifying the corresponding shopping cart when communicating with the server later on.

Meanwhile, the description of the present invention is focused on the case when the shopping cart according to the embodiment of the present invention is equipped with a barcode reader. However, the scope of the present invention may also include cases when the above-described barcode is replaced with Quick Response (QR) codes or Near Field Communication (NFC) tags, and the scope of the present invention may also include using a QR code scanner or an NFC tag scanners instead of the barcode readers. However, the description of the present invention will be based on the usage of a barcode reader, for simplicity.

Furthermore, according to another embodiment of the present invention, the shopping cart 300 may further include a weight detection sensor 304 configured to secondarily checking for any illegitimately (or improperly) loaded products (or items).

Moreover, according to yet another embodiment of the present invention, the shopping cart 300 may further include a communication module enabling data to be transmitted to a server, which manages the supermarket, and a controller controlling the communication module so that the information on at least one or more products loaded in the shopping cart 300 can be transmitted to the server. This will be described now with reference to FIG. 4.

FIG. 4 is a detailed block view showing an inner configuration module of the shopping cart according to an embodiment of the present invention. Hereinafter, the inner configuration module of the shopping cart according to the embodiment of the present invention will be described with reference to FIG. 4. However, it will be apparent that the components shown in FIG. 4 are merely examples and that the scope of the present will not be limited only to the examples shown in FIG. 4. And, as a general rule, the scope of the present invention shall be decided by the appended claims of the present invention. Therefore, the scope of the present invention may include designing the embodiment of the present invention by deleting some of the components shown in FIG. 4 or by adding new components that are not shown in FIG. 4.

As shown in FIG. 4, the shopping cart 400 according to an embodiment of the present invention may include a barcode reader 401, a motion recognition sensor 402, a camera module 403, a weight recognition sensor 404, a communication module 405, a memory 406, and a main controller 407.

More particularly, it is assumed in FIG. 4 that the barcode reader 401 is attached to the shopping cart 400. However, the scope of the present invention includes not only the barcode readers that are detachable but also barcode readers that are fixed to the shopping carts.

First of all, the barcode reader 401 is designed to be capable of reading the barcode of at least one or more products (or items) displayed or located in a supermarket. Also, the monitoring module determines whether or not a random item located in the supermarket is legitimately (or properly) loaded in the shopping cart 400. Herein, the monitoring module includes the motion recognition sensor 402, the camera module 403, and the weight recognition sensor 404 shown in FIG. 4.

The communication module 405 is designed to enable data to be transmitted to the server, which manages the supermarket. In addition, according to another embodiment of the present invention, the communication module 405 may also receive data from the server.

Additionally, the main controller 407 controls the communication module 405 so that the information on at least one or more products loaded in the shopping cart 400 can be transmitted to the server.

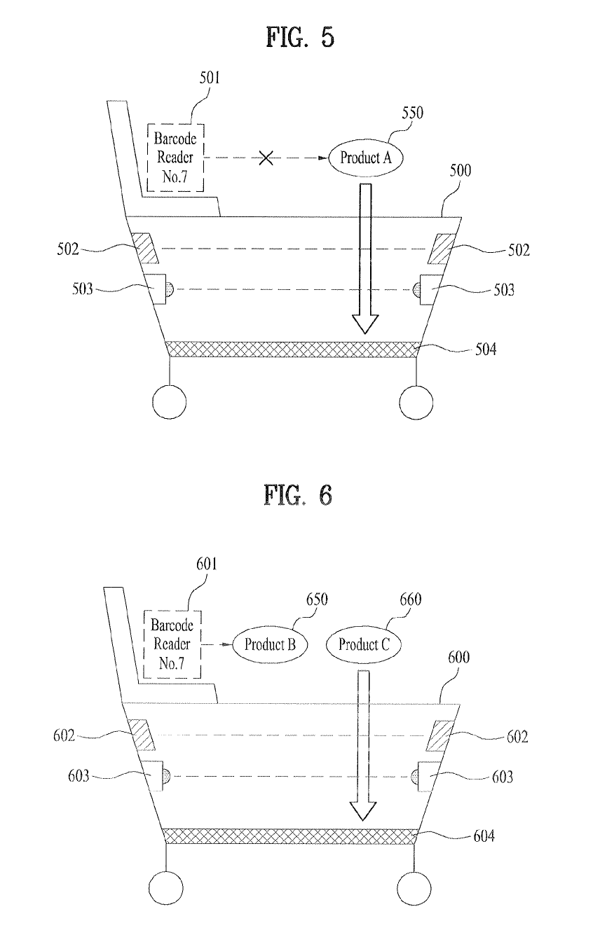

Also, the monitoring module of the shopping cart 400 according to the other embodiment of the present invention includes a motion recognition sensor 402 and a camera module 403. More specifically, the motion recognition sensor 402 is capable of detecting when a product (or item) that has failed to be read by the barcode reader is loaded in the shopping cart 400. And, the camera module 403 captures (or takes a picture of) the moment when such case is detected. This will be described in more detail with reference to FIG. 5.

The motion recognition sensor 402 may, for example, use an infrared sensor or a thermal sensor. Herein, the infrared sensor refers to a sensor that can detect infrared light rays and notify such detection, and the infrared sensor may be categorized as an active infrared sensor and a passive infrared sensor.

Herein, the active infrared sensor is provided with two (2) or more sensors. The active infrared sensor uses a method wherein infrared light rays are emitted from one side (light emitting unit), and wherein another side (light receiving unit) receives the infrared light rays emitted from the light emitting unit, thereby detecting the type of the object that is placed between the light emitting unit and the light receiving unit.

The passive infrared sensor refers to an infrared sensor that does not separately require a light emitting unit and that only includes a light receiving unit. More specifically, the passive infrared sensor uses a method wherein the light receiving unit simply detects (or senses) heat emitted from the outside and notifies such heat detection.

Furthermore, in addition to the motion recognition sensor 402 and the camera module 403, the monitoring module of the shopping cart according to yet another embodiment of the present invention may further include a weight detection sensor 404, which compares weight information of a specific product (or item) read out from the barcode of the product by the barcode reader at a first time point (or time point 1) with the change in weight, i.e., the increased weight, from the total weight measured at the first time point (or time point 1). Then, based upon the compared result, if the difference in weight is not within a predetermined difference range, the controller 407 controls the communication module so that the image data captured by the camera module can be transmitted to the server.

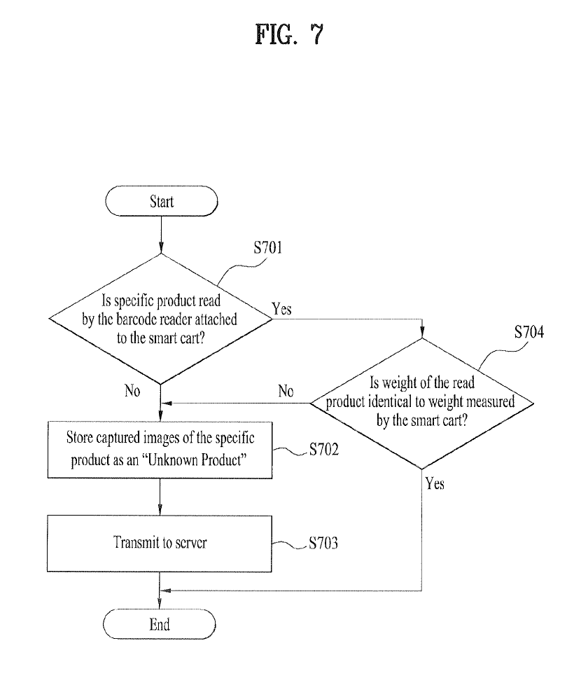

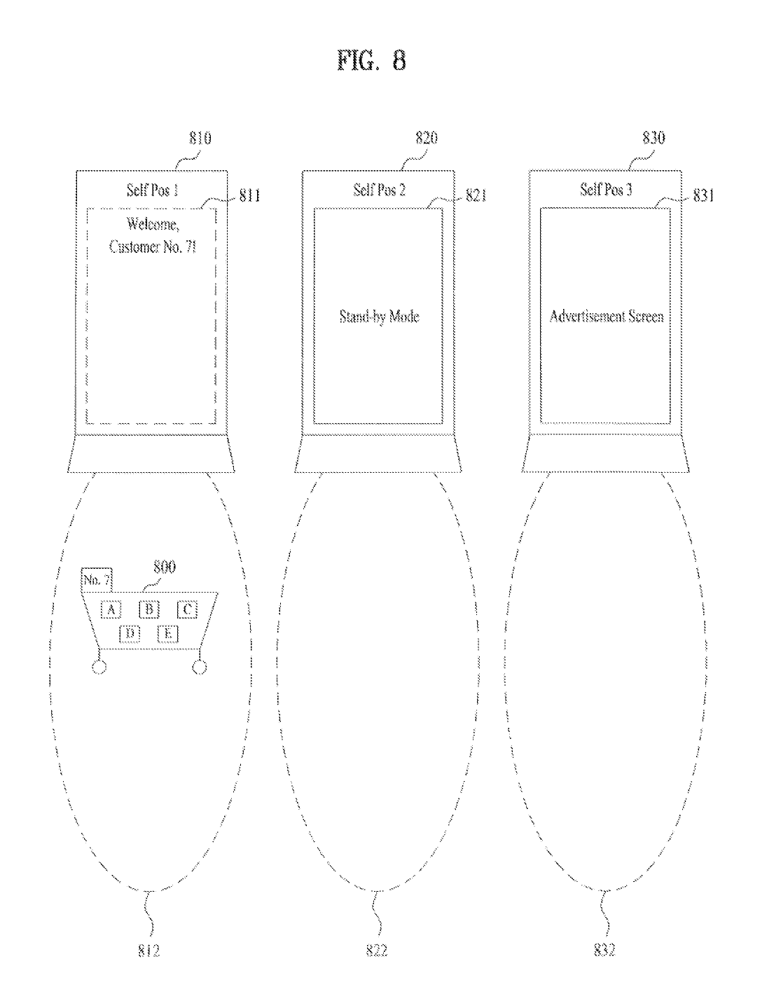

For example, it will be assumed that the total weight of products loaded in the shopping cart 400 measured at 09:00 a.m. (current time) is 1 kilogram (1 Kg). Then, 10 minutes later, at 09:10 a.m., the customer (or user) using the shopping cart 400 touches the barcode of product A (weighing 100 grams (100 g)) to the barcode reader either intentionally or by mistake, and, then, the user loads product B (weighing 500 g) in the shopping cart 400 instead of product A. In this instance, it may be determined by the weight detection sensor 404 of the shopping cart 400 that an illegitimate (or improper or incorrect) product (or item) is loaded in the shopping cart 400. This will be described in more detail later on with reference to FIG. 6.

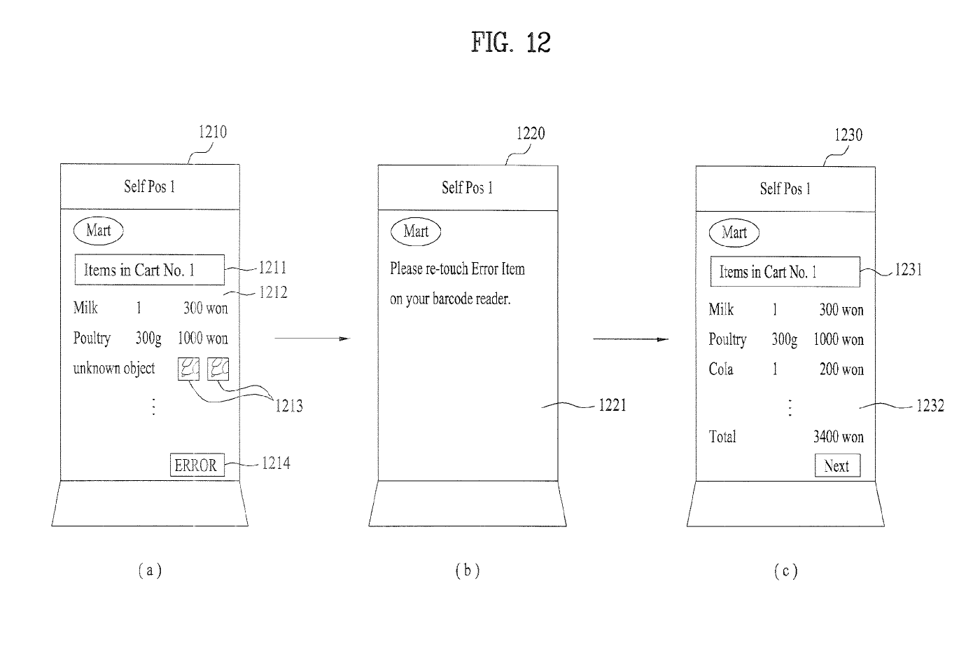

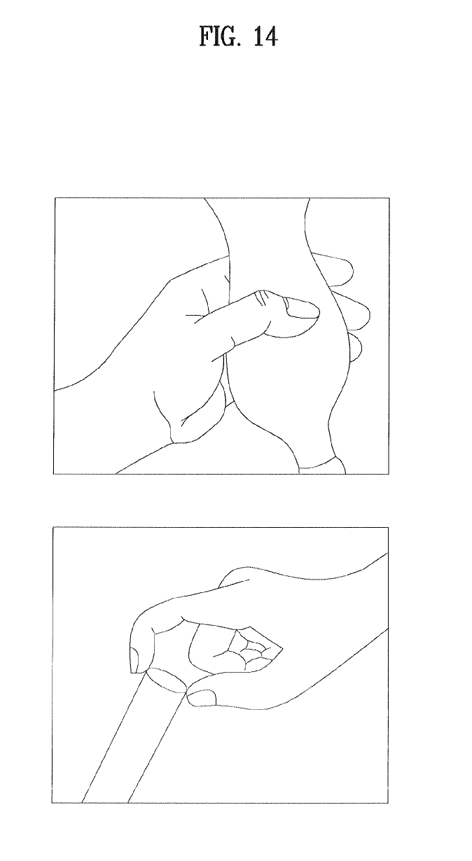

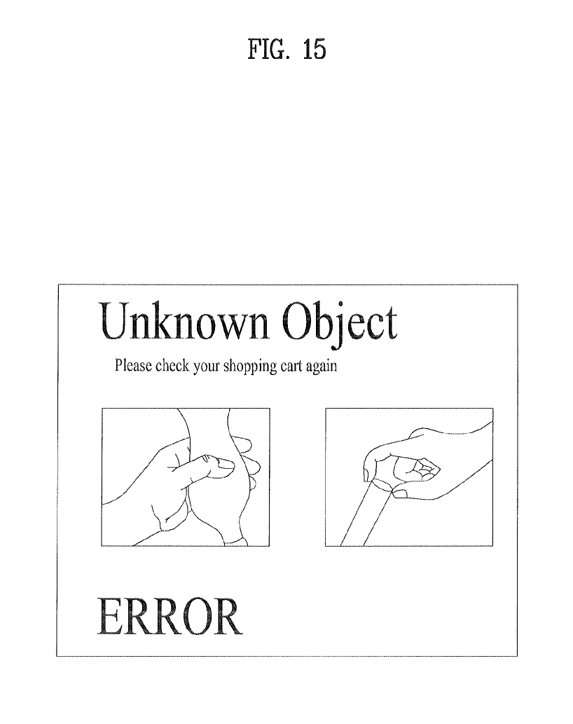

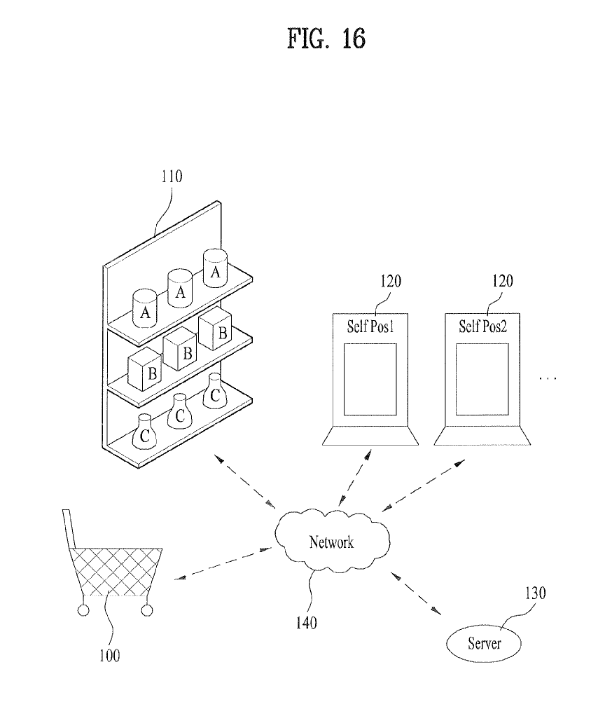

Meanwhile, if the above-described situation has occurred purely by the customer's mistake, it is very likely that the customer is not aware of such mistake. Therefore, information on a product that has not been properly read (i.e., unsuccessfully read) by the barcode reader is required to be notified to the customer using the corresponding shopping cart 400 by the server. This will be described in more detail later on with reference to FIG. 12, FIG. 14, and FIG. 15.

Meanwhile, the above-described barcode reader may further include a memory storing unique identification information identifying each of the at least two or more barcode readers. More specifically, as shown in FIG. 3, since the barcode reader 301 stores a unique identification number (e.g., Number 7 (or No. 7)) in its memory, the shopping cart being equipped with the barcode reader 301 may be identified. Furthermore, the server communicating with the shopping carts in the supermarket may be capable of identifying the specific shopping cart that has just been communicating with the server.

Also, the communication module 405 is designed to be capable of transmitting and receiving data to and from the digital signage display, which provides a list of products that are read by the barcode reader 401 shown in FIG. 4. Herein, the digital signage display is located within the premises of the supermarket.

Furthermore, the motion recognition sensor 402 corresponds to at least one or more infrared sensors. As described above, the infrared sensor is designed to operate as an active infrared sensor or as a passive infrared sensor.

FIG. 5 illustrates a first solution for monitoring a product that is being illegitimately (or improperly) loaded in a shopping cart according to an embodiment of the present invention.

As shown in FIG. 5, the shopping cart 500 according to the embodiment of the present invention may include a barcode reader 501, a motion recognition sensor 502, a camera module 503, and a weight recognition sensor 504. In addition, the shopping cart 500 shown in FIG. 5 is merely exemplary. Also, the barcode reader 501 may be designed as a barcode reader fixed to the shopping cart, or the barcode reader 501 may be designed to be held by a holder, so as to be detachably fixed to the shopping cart.

For example, the following description will be made under the assumption that, among the products being located and displayed in the supermarket, product A 550 is loaded in the shopping cart 500 without being recognized (or read) by the barcode reader 501.

Product A 550, which is not recognized (or read) by the barcode reader 501 is primarily detected by the motion recognition sensor 502. Additionally, the camera module 503 is activated at the moment the motion recognition sensor 502 senses (or detects), for example, the hand of the user (or customer). Meanwhile, according to another embodiment of the present invention, when a specific product (or item) is successfully (or normally/properly) read by the barcode reader, the motion recognition sensor 502 is not required to be operated. Therefore, the barcode reader may be designed so that the motion recognition sensor 502 can maintain its inactive state during a predetermined period of time (e.g., 1 second or more) that is required for the customer (or user) to load the specific product in the shopping cart, starting from the time point when the specific product is read by the barcode reader.

Accordingly, the camera module 503 may be capable of capturing the exact moment when product A 550 is being illegitimately (or improperly) loaded in the shopping cart 500. In addition, although FIG. 5 shows an example of the shopping cart equipped with two camera modules, the scope of the present invention may also include embodiments of shopping carts being equipped with only one camera module or at least 3 or more camera modules, as required.

FIG. 6 illustrates a second solution for monitoring a product that is being illegitimately (or improperly) loaded in a shopping cart according to an embodiment of the present invention. Hereinafter, the second solution for monitoring a product that is being illegitimately (or improperly) loaded in the shopping cart according to the embodiment of the present invention will be described in detail with reference to FIG. 6.

More particularly, unlike the first solution shown in FIG. 5, the second solution corresponds to a solution designed to resolve the problems that may occur when the user of the shopping cart loads a product other than the product read by the barcode reader in the shopping cart intentionally or by mistake.

As shown in FIG. 6, the shopping cart 600 according to the embodiment of the present invention may include a barcode reader 601, a motion recognition sensor 602, a camera module 603, and a weight recognition sensor 604. In addition, the shopping cart 600 shown in FIG. 6 is merely exemplary. Also, the barcode reader 601 may be designed as a barcode reader fixed to the shopping cart, or the barcode reader 601 may be designed to be held by a holder, so as to be detachably fixed to the shopping cart.

For example, the following description will be made under the assumption that, among the products being located and displayed in the supermarket, although product B 650 is recognized (or read) by the barcode reader 601, product C 660, which is not recognized by the barcode reader 601, is loaded in the shopping cart 600 instead of product B 650.

However, in this instance, the barcode reader 601 is designed to be capable of accurately reading all information on the corresponding product B 650 including the weight information of product B 650. The barcode of product B 650 may include price information and weight information.

Therefore, by using the weight detection sensor 604, the shopping cart 600 may easily verify that product C 660, which is currently loaded in the shopping cart 600, is different from the product 650, which is recognized by the barcode reader 601.

Furthermore, unlike the solution described in FIG. 5, the shopping cart 600 is designed to have its motion recognition sensor 602 and camera module 603 be activated all the time. In addition, the camera module 603 may be designed to capture (or take pictures) of all items (or products) loaded in the shopping cart 600. However, the image data of the image-captured products are not required to be all stored in the memory. More specifically, the second solution may be designed so that only the image data corresponding to the products, which are determined to be erroneous (i.e., unknown or wrong) by the motion recognition sensor, are transmitted to the server.

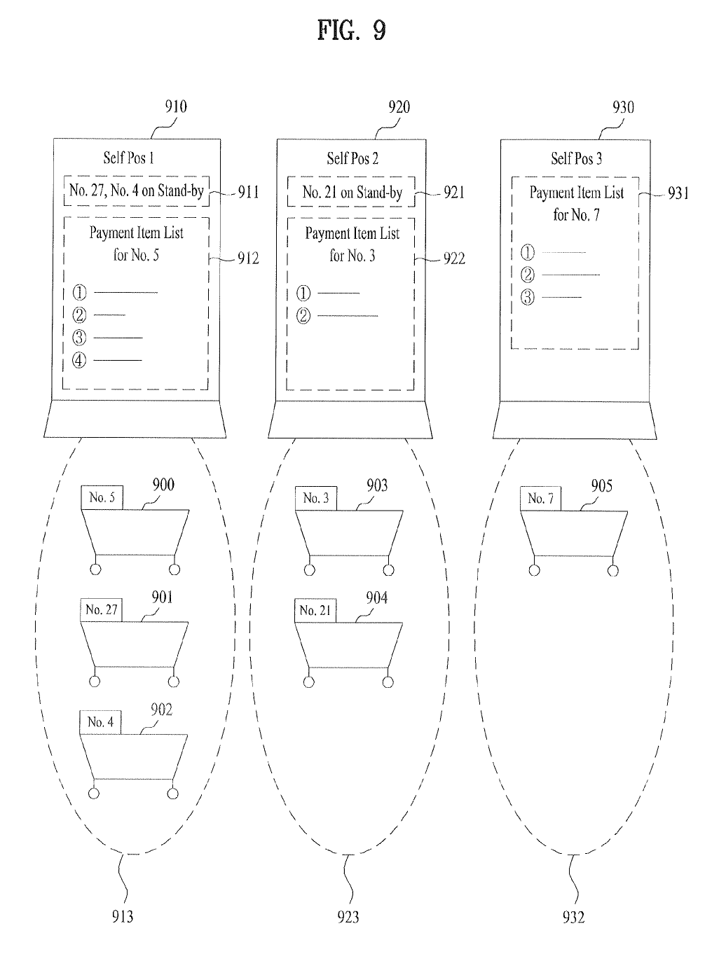

FIG. 7 is a flow chart showing a method for monitoring a product that is being illegitimately (or improperly) loaded in a shopping cart according to an embodiment of the present invention. Hereinafter, the detailed method for controlling the solutions described with reference to FIG. 5 and FIG. 6 will now be described in detailed based upon the flow chart shown in FIG. 7.

First of all, a smart shopping cart (hereinafter referred to as “smart cart”) according to the embodiment of the present invention determines whether or not a specific product has been read by the barcode reader attached to the smart cart (S701).

Then, based upon the result of step S701, when it is determined that the specific product has not been read by the barcode reader, image data of the corresponding product, which are captured (or taken) by the camera module, are stored as an unknown product (S702). Then, the smart cart transmits the stored information to the server (S703).

Furthermore, although it is not shown in FIG. 7, when the shopping cart (or smart cart) approaches the digital signage display according to the embodiment of the present invention, the digital signage display may request for information on the corresponding smart cart to the server. Thereafter, the server transmits the received image data on the unknown product to the digital signage display.

Conversely, based upon the result of step S701, when it is determined that the specific product has been read by the barcode reader, the smart cart determines whether or not the weight of the product read by the barcode reader is identical to the weight measured by the weight recognition sensor of the smart cart (S704).

Thereafter, based upon the result of step S704, when it is determined that the weights are different from one another, the process returns the step S702. Also, when it is determined that the weights are identical, the smart cart determines that the corresponding product is not erroneous.

FIG. 8 illustrates a method performed by a digital signage display for recognizing a single shopping cart and a user interface according to an embodiment of the present invention. As described above, with reference to FIG. 1 to FIG. 7, the shopping cart according to the embodiment of the present invention transmits information on the products loaded therein to the server. Therefore, as opposed to the related art environment, it is no longer required for the employees of the supermarket to check the POS terminals in person. Hereinafter, more particularly, the digital signage display that can replace the above-described POS terminals will be described in detail.

As shown in FIG. 8, digital signage displays 810, 820, and 830 according to the embodiment of the present invention are each provided with a communication range 812, 822, and 832 allowing a random shopping cart 800 to be recognized. More specifically, for example, each of the digital signage displays 810, 820, and 830 can recognize a random shopping cart 800 via Bluetooth or WI-Fi communication.

For example, when the random shopping cart 800 is located within the communication range 812 of the first digital signage display 810, the first digital signage display 810 outputs a message 811 notifying that the random shopping cart 800 has been recognized. As described above, since the shopping cart 800 is assigned with a unique identification number, the shopping cart 800 may transmit data corresponding to the unique identification number to the first digital signage display 810. Also, the unique identification number is also designed to be displayed on the outside surface of the barcode reader. Acccordingly, the user of the corresponding shopping cart 800 may easily verify that his (or her) shopping cart has been recognized by a digital signage display.

Meanwhile, the second digital signage display 820, which has failed to recognize the shopping cart 800, may display random video data 821 indicating a stand-by (or waiting) screen. And, the third digital signage display 830, which has also failed to recognize the shopping cart 800, may display an advertisement screen 831.

Therefore, the scope of the present invention may also include the variations of the above-described display screen 811, 821, and 831, based upon whether or not a random shopping cart has been recognized.

Next, FIG. 9 illustrates a method performed by a digital signage display for recognizing multiple shopping carts and a user interface according to an embodiment of the present invention. Hereinafter, the method performed by the digital signage display for recognizing multiple shopping carts and the user interface according to the embodiment of the present invention will be described in detail. Unlike the method described with reference to FIG. 8, it is assumed in FIG. 9 that multiple smart carts exist and are being used.

First of all, when a shopping cart 900 equipped with barcode reader No. 5 is located with the communication range 913 of the first digital signage display 910, the first digital signage display 910 receives information on the items (or products) recognized by barcode reader No. 5 by communicating with the above-described server. Then, based upon the received information, the first digital signage display 910 displays a list 912 of the products loaded in the smart cart 900 equipped with barcode reader No. 5.

Meanwhile, it will be assumed that, before the final payment for the products loaded in the smart cart 900 equipped with barcode reader No. 5 is processed, a shopping cart (or smart cart) 901 equipped with barcode reader No. 27 and a shopping cart (or smart cart) 902 equipped with barcode reader No. 4 are both located within the communication range 913 of the first digital signage display 910. At this point, the first digital signage display 910 displays an additional message 911 indicating that barcode reader No. 27 and barcode reader No. 4 are on stand-by (or waiting).

Accordingly, the display of the additional message 911 is typically advantageous in that the users of the shopping carts 901 and 902, which are on stand-by, may easily verify that a digital signage display has recognized the shopping carts 901 and 902 and that their payment will soon be processed.

Moreover, when a shopping cart 903 equipped with barcode reader No. 3 is located with the communication range 923 of the second digital signage display 920, the second digital signage display 920 receives information on the items (or products) recognized by barcode reader No. 3 by communicating with the above-described server. Then, based upon the received information, the second digital signage display 920 displays a list 922 of the products loaded in the smart cart 903 equipped with barcode reader No. 3.

Meanwhile, it will be assumed that, before the final payment for the products loaded in the smart cart 903 equipped with barcode reader No. 3 is processed, a shopping cart 904 equipped with barcode reader No. 21 is located within the communication range 923 of the second digital signage display 920. At this point, the second digital signage display 920 displays an additional message 921 indicating that barcode reader No. 21 is on stand-by (or waiting).

Finally, when a shopping cart (or smart cart) 905 equipped with barcode reader No. 7 is located with the communication range 933 of the third digital signage display 930, the third digital signage display 930 receives information on the items (or products) recognized by barcode reader No. 7 by communicating with the above-described server. Then, based upon the received information, the third digital signage display 930 displays a list 932 of the products loaded in the smart cart 905 equipped with barcode reader No. 7. In this instance, there is no additional shopping cart (or smart cart) on stand-by.

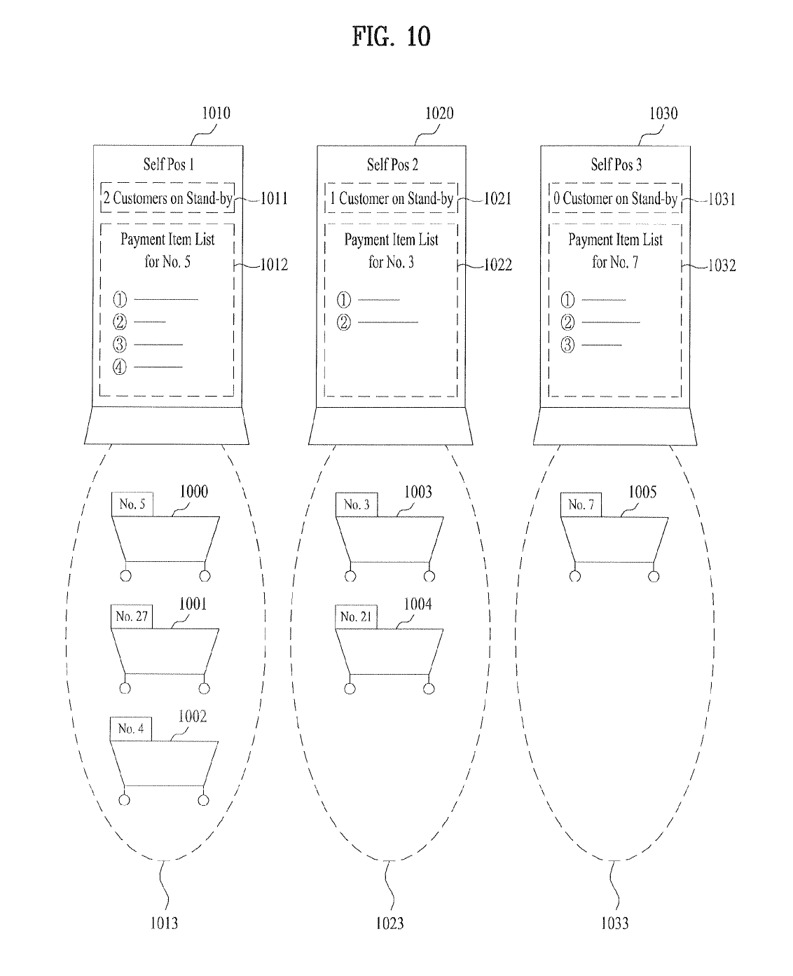

FIG. 10 illustrates a method performed by a digital signage display for recognizing multiple shopping carts and a user interface according to another embodiment of the present invention. Unlike the embodiment shown in FIG. 9, the embodiment shown in FIG. 10 corresponds to a user interface simply notifying the number of carts that have been recognized.

First of all, when a shopping cart 1000 equipped with barcode reader No. 5 is located with the communication range 1013 of the first digital signage display 1010, the first digital signage display 1010 receives information on the items (or products) recognized by barcode reader No. 5 by communicating with the above-described server. Then, based upon the received information, the first digital signage display 1010 displays a list 1012 of the products loaded in the smart cart 1000 equipped with barcode reader No. 5.

Meanwhile, it will be assumed that, before the final payment for the products loaded in the smart cart 1000 equipped with barcode reader No. 5 is processed, a shopping cart (or smart cart) 1001 equipped with barcode reader No. 27 and a shopping cart (or smart cart) 1002 equipped with barcode reader No. 4 are both located within the communication range 1013 of the first digital signage display 1010. At this point, the first digital signage display 1010 displays an additional message 1011 indicating that barcode reader No. 27 and barcode reader No. 4 are on stand-by (or waiting).

Accordingly, the display of the additional message 1011 is advantageous in that the user of the shopping cart 1000, who is currently processing payment, may check the number of waiting customers and speed up his (or her) payment process or take his (or her) time in processing the payment.

Moreover, when a shopping cart (or smart cart) 1003 equipped with barcode reader No. 3 is located with the communication range 1023 of the second digital signage display 1020, the second digital signage display 1020 receives information on the items (or products) recognized by barcode reader No. 3 by communicating with the above-described server. Then, based upon the received information, the second digital signage display 1020 displays a list 1022 of the products loaded in the smart cart 1003 equipped with barcode reader No. 3.

Meanwhile, it will be assumed that, before the final payment for the products loaded in the smart cart 1003 equipped with barcode reader No. 3 is processed, a shopping cart (or smart cart) 1004 equipped with barcode reader No. 21 is located within the communication range 1023 of the second digital signage display 1020. At this point, the second digital signage display 1020 displays an additional message 1021 indicating that one user (or customer) is on stand-by (or waiting).

Finally, when a shopping cart (or smart cart) 905 equipped with barcode reader No. 7 is located with the communication range 1033 of the third digital signage display 1030, the third digital signage display 1030 receives information on the items (or products) recognized by barcode reader No. 7 by communicating with the above-described server. Then, based upon the received information, the third digital signage display 1030 displays a list 1032 of the products loaded in the smart cart 1005 equipped with barcode reader No. 7 and also displays an additional message 1031 notifying that 0 customers are on stand-by (or waiting). In addition, it will be included in the scope of the present invention that the contents of the additional message 1031 may vary depending upon the number of smart carts, which have been additionally recognized.

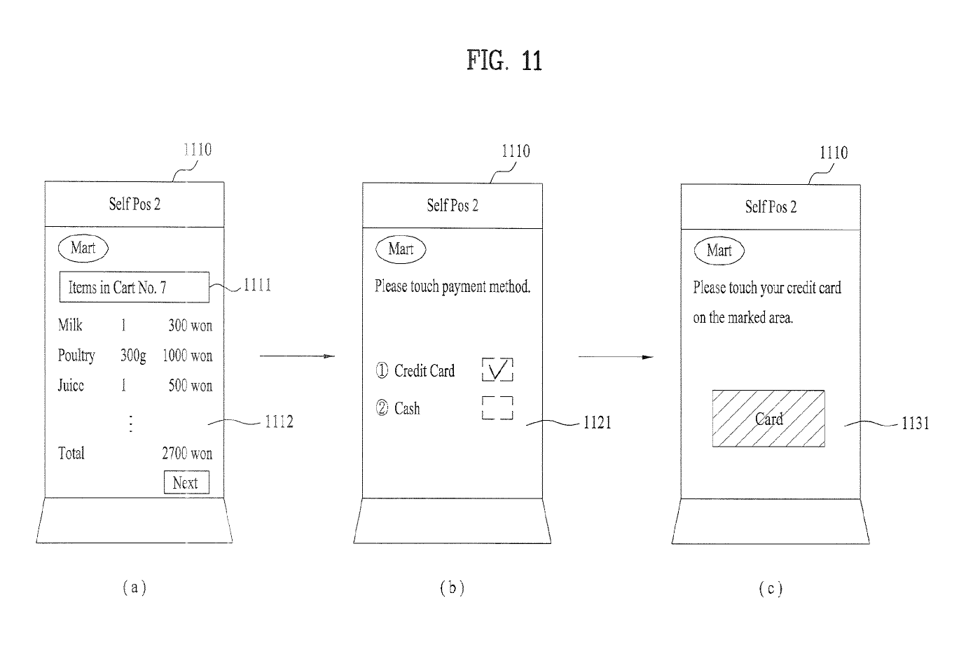

FIG. 11 illustrates a method performed by a digital signage display for automatically recognizing and processing purchased and paid products according to an embodiment of the present invention by the respective time order.

First of all, according to the embodiments of the present invention described above with reference to FIG. 1 to FIG. 10, referring to FIG. 11, it will be assumed that the digital signage display 1110, shown in FIG. 11, recognizes a specific smart cart and that the digital signage display 1110 receives information on the recognized smart cart from the server.

As shown in (a) of FIG. 11, the digital signage display 1110 according to the embodiment of the present invention displays a message 1111 identifying a recognized smart cart. Moreover, the digital signage display 1110 automatically displays a list 1112 of items (or products) loaded in the recognized smart cart, after receiving the list 1112 from the server. Thus, the inconvenience of the related art method of having to touch each item loaded in the shopping cart with the barcode reader may be resolved. More particularly, an aspect of the present invention is to provide an innovative method of eliminating the waste in time and human resource required in the initial payment process.

When a “Next” option, which is located in a lower area of a display screen shown in (a) of FIG. 11, is selected, the digital signage display 1110 according to the embodiment of the present invention outputs a message 1121 providing guidance for processing the payment method, as shown in (b) of FIG. 11. More specifically, the digital signage display shown in FIG. 11 is designed to additionally include a touch sensor that can recognize the touch of a human hand.

Meanwhile, when a “Credit Card” item is selected, as shown in (b) of FIG. 11, the digital signage display 1110 shown in (c) of FIG. 11 outputs an on-screen display (OSD) screen 1131 guiding the user (or customer) to a position for touching the user's credit card.

In short, the smart cart according to the embodiment of the present invention transmits information on the products purchased by the customer (or user) to a database of the server in real time. Therefore, it is advantageous in that a digital signage display, which can communicate with the service, may immediately display the payment information. Also, by using the method proposed in the present invention, the supermarket may prevent in advance the forming of long waiting lines for the final payment.

FIG. 12 illustrates a method performed by a digital signage display for automatically recognizing and processing purchased and paid products according to another embodiment of the present invention by the respective time order. As shown in (a) of FIG. 12, the digital signage display 1210 according to the embodiment of the present invention displays a message 1211 identifying a recognized smart cart. Moreover, the digital signage display 1210 automatically displays a list 1212 of items (or products) loaded in the recognized smart cart, after receiving the list 1212 from the server.

Although it is assumed in FIG. 11 that all products loaded in the specific shopping cart have been successfully (or normally) read by the barcode reader, referring to FIG. 12, the following description of the present invention will be mainly focused on a user interface, which is configured to process erroneous products (or items).

First of all, according to the embodiments of the present invention described above with reference to FIG. 1 to FIG. 10, referring to FIG. 12, it will be assumed that the digital signage display 1210, shown in FIG. 12, recognizes a specific smart cart and that the digital signage display 2110 receives information on the recognized smart cart from the server.

However, as described above, the present invention is designed so that information on the products (or items) that have been unsuccessfully read by the barcode reader can be separately managed as an unknown item, and so that the image of the corresponding moment can be captured by the camera module.

More specifically, as shown in (a) of FIG. 12, the list 1212 includes image data 1213 of the products that have not been legitimately recognized by the barcode reader for payment. Also, in order to enhance the user's recognition, the digital signage display 1210 may additionally display a message 1214 indicating that an error has occurred and, therefore, the payment cannot be processed in the current step.

More particularly, as shown in (a) of FIG. 12, if image data 1213 of the products that have not been properly recognized by the barcode reader are output along with the list 1212, it may be advantageous in that the user can quickly verify the erroneous products (or items). Detailed examples of the above-described image data will be described in more detail later on with reference to FIG. 14 and FIG. 15.

When the error message 1214, shown in (a) of FIG. 12, is selected, the digital signage display 1220 outputs a notification message 1221 directing the user to touch the erroneous product on the barcode reader once again, as shown in (b) of FIG. 12.

Thereafter, if the barcode reader has successfully recognized the erroneous product, the digital signage display 1230 displays once again a message 1231 identifying the recognized smart cart and the total payment list 1232. Also, by displaying a “Next” option on a lower area of the display screen, the user may move on to the next payment process step. For example, successful payment is performed through step (b) and step (c) of FIG. 11.

As described above, when products that have failed to be properly read by the barcode reader are loaded in the shopping cart, the moment when the corresponding product is being loaded in the shopping cart is captured, and the respective image data are displayed on the digital signage display.

Therefore, by referring to the displayed image data, the user may correct the payment for the erroneous product(s). Thus, any intentional theft made by a random user may be prevented in advance.

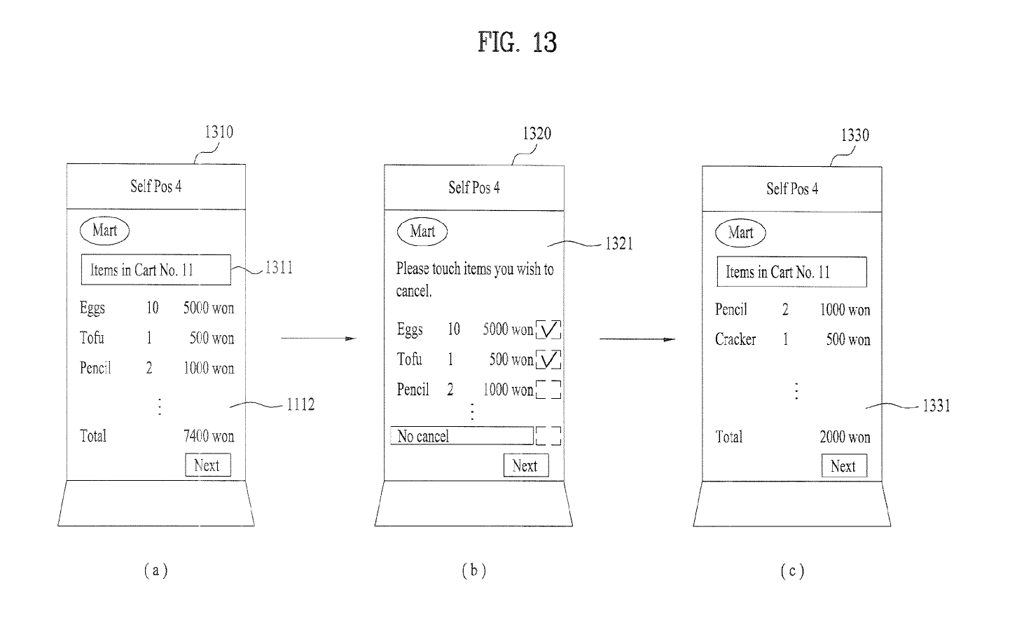

FIG. 13 illustrates a method performed by a digital signage display for automatically recognizing and processing purchased and paid products according to yet another embodiment of the present invention by the respective time order.

First of all, according to the embodiments of the present invention described above with reference to FIG. 1 to FIG. 10, referring to FIG. 13, it will be assumed that the digital signage display 1310, shown in FIG. 13, recognizes a specific smart cart and that the digital signage display 1310 receives information on the recognized smart cart from the server.

As shown in (a) of FIG. 13, the digital signage display 1310 according to the embodiment of the present invention displays a message 1311 identifying a recognized smart cart. Moreover, the digital signage display 1310 automatically displays a list 1312 of items (or products) loaded in the recognized smart cart, after receiving the list 1312 from the server.

When a “Next” option, which is located in a lower area of a display screen shown in (a) of FIG. 13, is selected, the digital signage display 1310 according to the embodiment of the present invention outputs a message 1321 indicating the products that the user wishes to cancel, as shown in (b) of FIG. 13.

In addition, in (b) of FIG. 13, in order to cancel some of the purchased products, the cancelling process may be performed by using the barcode reader attached to the shopping cart according to the embodiment of the present invention. Then, the cancelled products are removed from the shopping cart. In (b) of FIG. 13, it is assumed that the user has canceled 10 eggs and one tofu.

Therefore, as shown in (c) of FIG. 13, the digital signage display 1330 newly outputs the corrected payment list 1331. When comparing the payment list shown in (a) of FIG. 13 with the corrected payment list 1331 shown in (c) of FIG. 13, the user may easily verify that the 10 eggs and one tofu, which have been canceled, are deleted from the payment list.

FIG. 14 illustrates a supplementary example of the digital signage displaying information on an erroneous object shown in FIG. 12, and FIG. 15 illustrates supplementary description of FIG. 14. Hereinafter, the image data showing the information on the erroneous products will be described in detail with reference to FIG. 14 and FIG. 15.

As described above, when the barcode reader fails to successfully (or properly) charge payment for a specific item, the camera attached to (or mounted on) the shopping cart beings to take pictures (or capture images), and the shopping cart transmits the respective image data to the server. Furthermore, the server transmits the received image data to the digital signage display, which then outputs the final data image 1213 on its display screen as shown in (a) of FIG. 12.

The initial image data taken (or captured) by the camera mounted on the shopping cart may be configured as shown in FIG. 14. For example, the original image data, which is shown in the left side of FIG. 14, corresponds to an image taken from a camera located at a front portion of the shopping cart, and the original image data, which is shown in the right side of FIG. 14, corresponds to an image taken from a camera located at a rear portion of the shopping cart. When using original image data taken from only one camera, it will be apparent that the designer of the present invention has considered the fact that the user may not be capable of properly recognizing the product corresponding to the image data.

Also, the original image data shown in FIG. 14 is processed by the server or the digital signage display. In addition, by outputting an unknown object message or an ERROR message along with the original image data, as shown in FIG. 15, the digital signage display may inform the user that the product corresponding to the captured data image should be touched by the barcode reader once again.

Hereinafter, a method for controlling the digital signage display according to an embodiment of the present invention will now be described in detail with reference to the above-described FIG. 8 to FIG. 15.

The method for controlling the digital signage display according to the embodiment of the present invention may include the steps of detecting a specific shopping cart being equipped with a barcode reader, receiving identification information corresponding to the specific shopping cart from the detected shopping cart, requesting information for listing at least one or more products corresponding to the received identification information to a server managing the supermarket, displaying information for listing the at least one or more products, the information being received from the server, and performing control operations for processing payment of a total charged sum for the products mounted in the shopping cart, based upon the displayed information.

The step of displaying information may further include the steps of outputting information on at least one or more products, which are successfully read by the barcode reader, in a first area of the digital signage display, and information on at least one or more products, which are unsuccessfully read by the barcode reader, in a second area of the digital signage display.

Herein, the information on the products corresponding to the step of outputting information in a second area of the digital signage display may further include image data taken by a camera module mounted on the specific shopping cart.

The step of performing control operations may further include performing control information so that payment may be processed by order of detection, when a plurality of specific shopping carts is detected in the step of detecting a specific shopping cart.

The method for controlling the digital signage according to the embodiment of the present invention may further include the steps of, when the number of detected shopping carts is equal to N in the step of detecting a specific shopping cart, creating a guidance message informing the user that N-1 number of shopping carts are on stand-by, and displaying the created guidance message.

The step of detecting a specific shopping cart being equipped with the barcode reader may further include the steps of outputting a first OSD screen corresponding to the stand-by mode, sensing whether or not a specific shopping cart is located within a range predetermined by the digital signage display, and, when the specific shopping cart is sensed to be located within the predetermined range, outputting a second OSD screen corresponding to the payment mode.

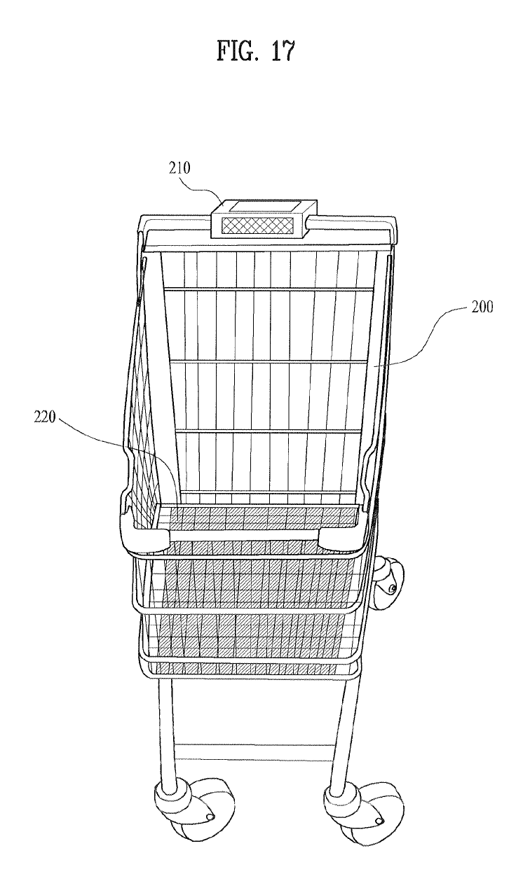

Next, FIG. 16 illustrates a general view of an overall system including a shopping cart, a digital signage display, and a server according to an embodiment of the present invention. It will be apparent that the elements (or components) shown in FIG. 16 are merely exemplary. Therefore, the present invention is not limited only to the elements shown in FIG. 16.

Referring to FIG. 16, it will be assumed that at least one or more shopping carts 100, at least one or more display devices 110, and at least one or more digital signage displays (hereinafter referred to as “digital signage”) 120 are positioned in a supermarket. According to the description of the present invention, the digital device 110 may refer to a display shelf displaying the at least one or more products located in the supermarket, or the digital device 110 may refer to a device connected to the display shelf In addition, herein, for example, a server 130 may be controlled by a subject managing the supermarket.

Also, as shown in FIG. 16, each shopping cart 100, each digital device 110, each digital signage 120, and the server 130 are connected to one common network. Accordingly, random data may be transmitted and received to and from one another via 2-way data communication. In addition, according to another embodiment of the present invention, the system may be configured so that the shopping carts 110 and the digital signage displays 120 can be connected through a first network, so that the shopping carts 100 and the digital signage displays 120 can be connected through a second network, so that the digital signage displays 120 and the server 130 can be connected through a third network, and so that the server 130 and the shopping carts 100 can be connected through a fourth network. More specifically, the scope of the present invention may include that the system is designed so that each component can be connected to a different network.

Moreover, according to the embodiment of the present invention, the digital signage display 120 corresponds to a solution that is newly developed in order to enhance point-of-sales (POS) terminals provided in the related art supermarket environments. Thus, the digital signage technology may resolve the problem of wasting resources, which is caused by payment processes performed by supermarket employees using the POS terminals.

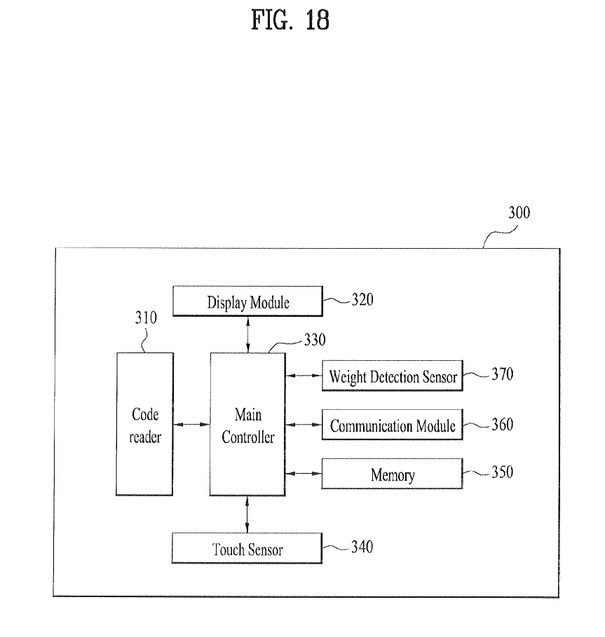

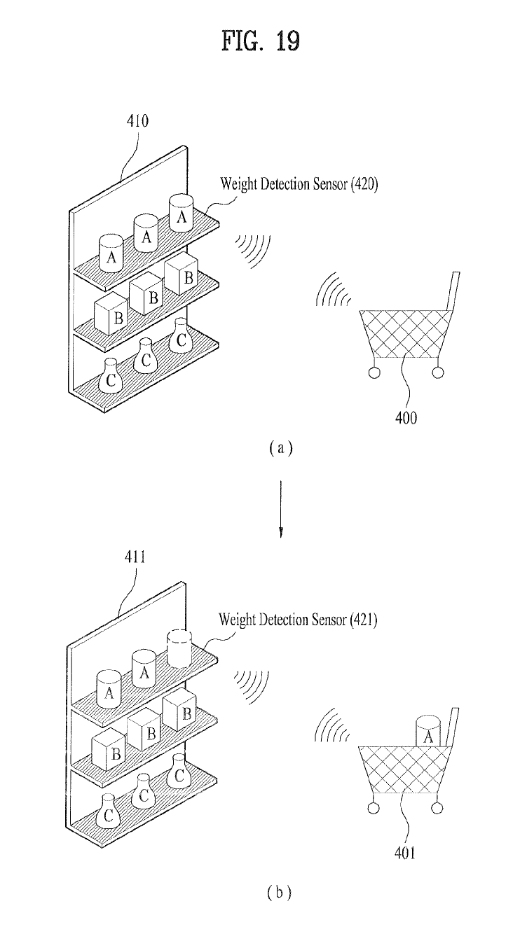

Furthermore, the shopping carts 100 according to the embodiment of the present invention may also be equipped with a display device including a code reader, the display device being detachably fixed to the shopping cart. The above-described shopping carts 100 and display devices according to the present invention will also be described in detail later on with reference to FIG. 17 to FIG. 18.

FIG. 17 illustrates a detailed view showing the outside features of a shopping cart 200 according to an embodiment of the present invention. Hereinafter, the overall outside features of the shopping cart according to the embodiment of the present invention will be described in detail.

Related art shopping carts are designed according to an analog method, thereby performing the role of simply carrying items. Conversely, as shown in FIG. 17, the shopping cart 200 according to the embodiment of the present invention is designed to be additionally provided with a display device 210 and a weight detection sensor 220. Moreover, the display device 210 includes a code reader, which can recognize code information attached to a product. In addition, the display device 210 is designed to be semi-permanently fixed to the shopping cart 200 or detachably fixed to the shopping cart 200.

Therefore, when using the shopping cart 200 shown in FIG. 17, the problem of wasting human resource by having employees of the supermarket manually use the barcode reader for each purchasing item so as to perform the final payment process is avoided. Furthermore, the payment process may be performed much more quickly.

Next, FIG. 18 illustrates a detailed block view showing an inner configuration module of a display device attachable to a shopping cart according to an embodiment of the present invention. Hereinafter, the functions of the display device and the code reader, which may be detachably fixed to the shopping cart, will be described in detail.

As shown in FIG. 18, a display device 300 attachable to a shopping cart includes a code reader 310, a display module 320, a main controller 330, a touch sensor 340, a memory 350, a communication module 360, and a weight detection sensor 370. In addition, the scope of the present invention also includes having the code reader 310 and the weight detection sensor 370 positioned outside of the display device 300, instead of being configured as inner components of the display device 300. Furthermore, the modules shown in FIG. 18 are merely exemplary.

The communication module 360 is designed to receive information on a specific product (or item) from a digital device displaying at least one or more products. The digital device will be described in more detail later on with reference to FIG. 19.

The code reader 310 performs the role of recognizing code information attached to a random product. For example, the code reader 310 corresponds to a barcode reader, a QR code scanner, an NFC tag scanner, and so on, each being capable of recognizing barcodes, QR codes, NFC tags, and so on.

The main controller 330 compares the code information of the product recognized by the code reader 310 with the received information on a specific product. The scope of the present invention may also include designing the present invention so that a separate module performing the above-described function can be included.

The display module 320 displays a guidance message in accordance with a control signal generated from the main controller 330. The scope of the present invention may also include allowing the user to select a random area of a screen, which is output through the display module 320, by using the touch sensor 340.

For example, information on the specific product includes at least one or more of weight information or code information of the specific product.

When the information on the specific product corresponds to weight information, the main controller 330 is designed to compare an added weight, which is recognized by the weight detection sensor 370, with the weight information of the specific product. For example, the weight detection sensor 370 may be designed to be located in a specific area 220 of the shopping cart, as shown in FIG. 2.

When the compared weights are identical to one another, the main controller 330 stores data, which indicates that the payment process can be performed, in the memory 350. Also, when the compared weights are different from one another, the main controller 330 stores data, which indicates that the payment process cannot be performed, in the memory 350.

Based upon the control of the main controller 330, when the compared weights are different from one another, the display module 320 outputs a guidance message indicating that the payment process cannot be performed.

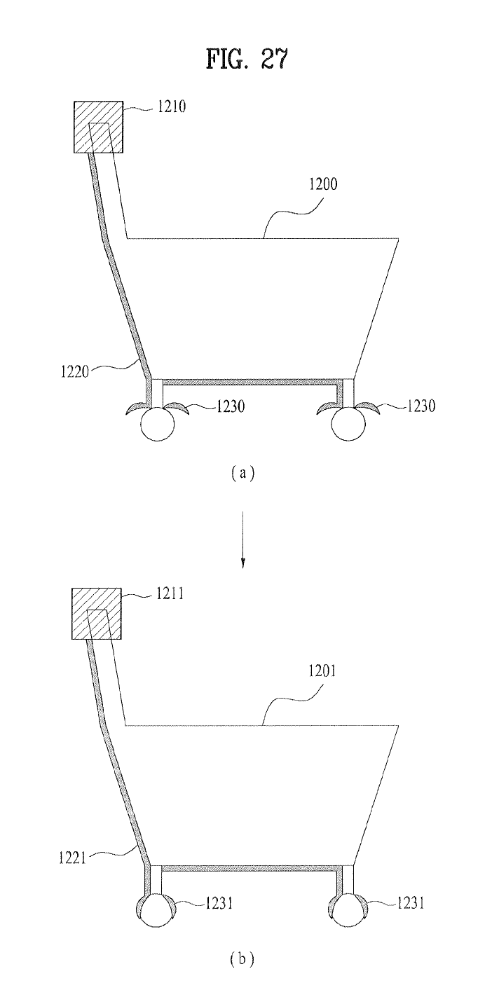

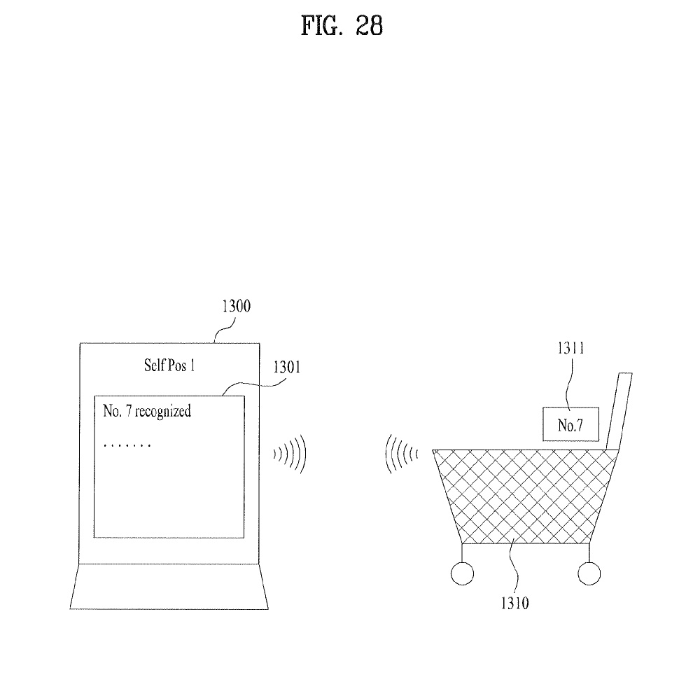

Also, when the compared weights are different from one another, the main controller 330 generates a command signal directing wheels of the shopping cart to be changed to a disable mode (or disabled lock state). This will be described in more detail with reference to FIG. 26 and FIG. 27.

FIG. 19 illustrates a general view showing a communication status between a shopping cart and a digital device according to an embodiment of the present invention.

As shown in FIG. 19, the shopping cart 400 and 401 and the digital device 410 and 411 are designed to perform data communication between one another. As described above, the digital device 410 and 411 may correspond to a display shelf displaying the at least one or more products located in the supermarket, or the digital device 410 and 411 may refer to a device connected to the display shelf

Moreover, the digital device 410 and 411 may include a close-range communication module, which can perform data communication with external devices (e.g., at least one or more shopping carts), and a weight detection sensor 420 and 421. Herein, for example, the close-range communication module corresponds to a communication module having a Bluetooth, ZigBee, or NFC communication protocol applied thereto. However, the scope of the present invention will not be limited only to the above-described module. Furthermore, when a random product is missing from a group of products displayed on a specific shelf, the weight detection sensor 420 and 421 is used for detecting weight information of the missing product.

First of all, as shown in (a) of FIG. 19, it will be assumed that the shopping cart 400 according to the embodiment of the present invention is located in an area, wherein communication with the digital device 410 displaying products is available. At this point, for example, the shopping cart 400 is equipped with the display device 300 shown in FIG. 18. Therefore, by using the communication module 360 shown in FIG. 18, the shopping cart 400 may communicate with the digital device 410.

Meanwhile, as shown in (b) of FIG. 19, when a random product displayed or placed on a specific shelf is placed in the shopping cart 401, the weight detection sensor 421 of the digital device 411 may determine that a product corresponding to the decreased weight has been removed from the display shelf Moreover, the digital device 411 transmits information on the decreased weight to the shopping cart 401. Therefore, by using the weight detection sensor mounted on the shopping cart 401, the shopping cart 401 may determine whether or not the total weight of the shopping cart 401 has increased as much as the weight information transmitted from the display device 411. When designing the present invention as described above, illegitimate (or improper) loading of a product in the shopping cart may be prevented.

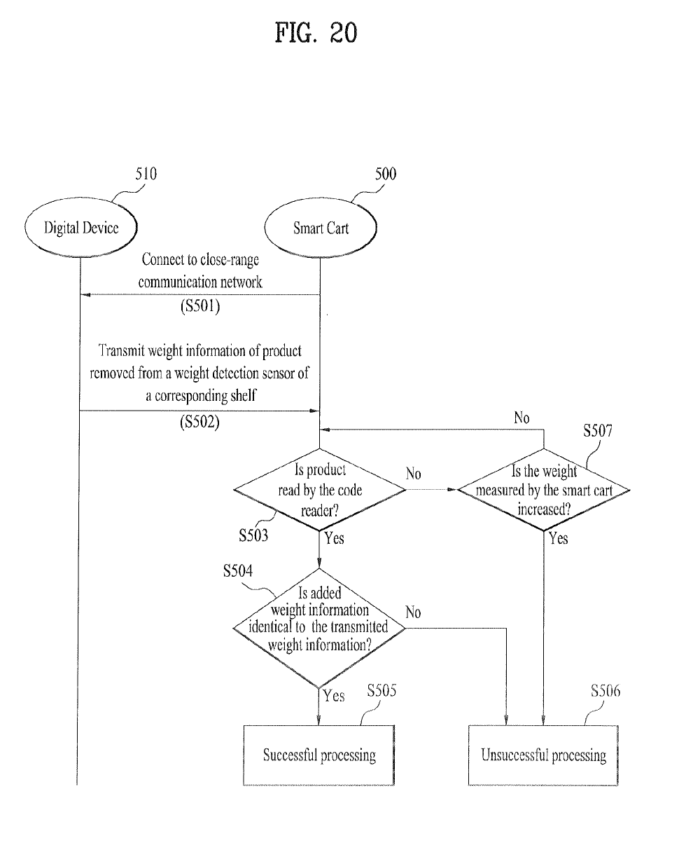

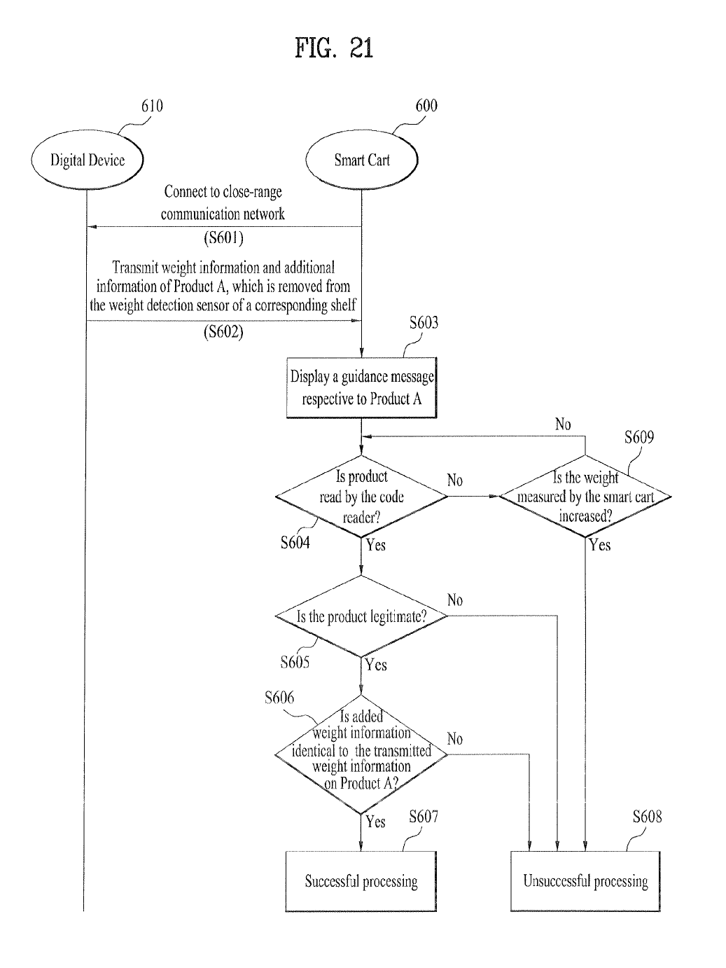

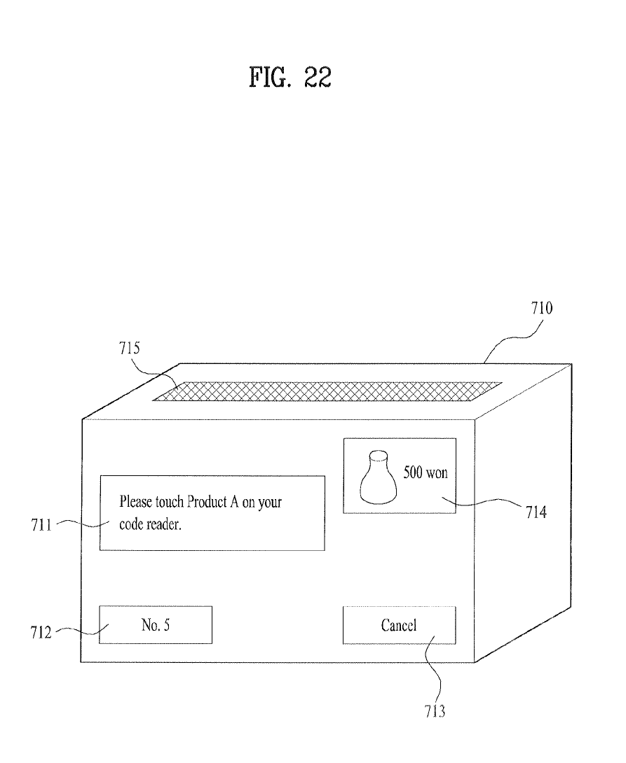

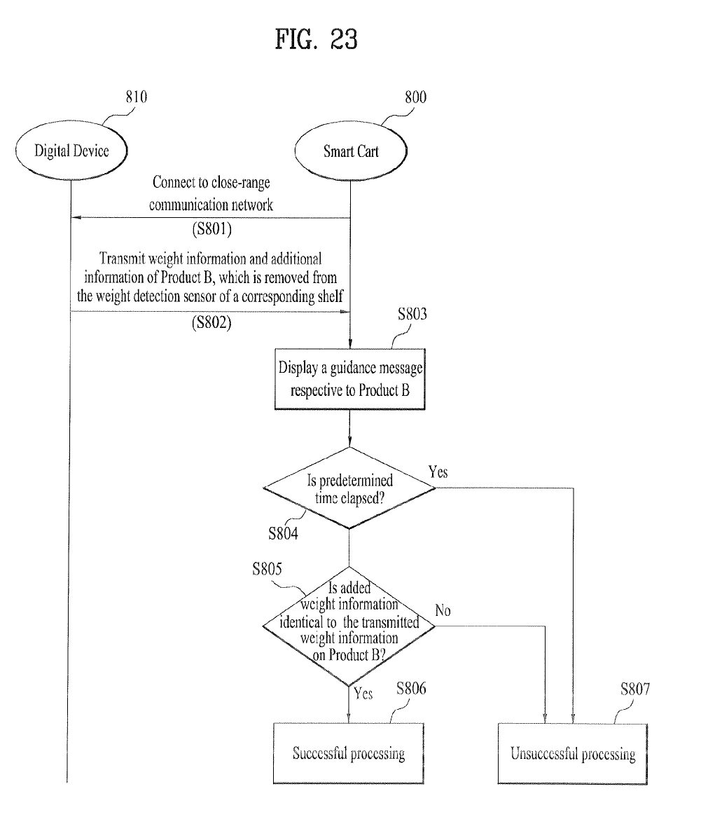

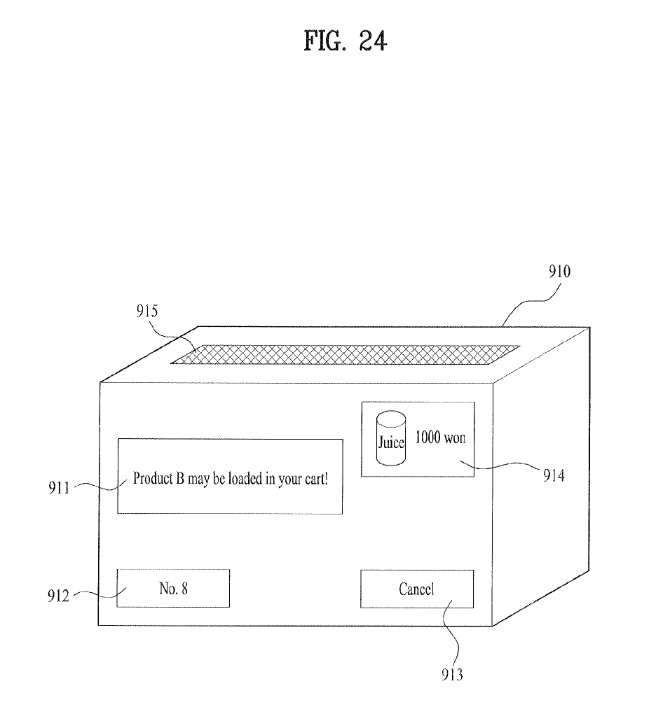

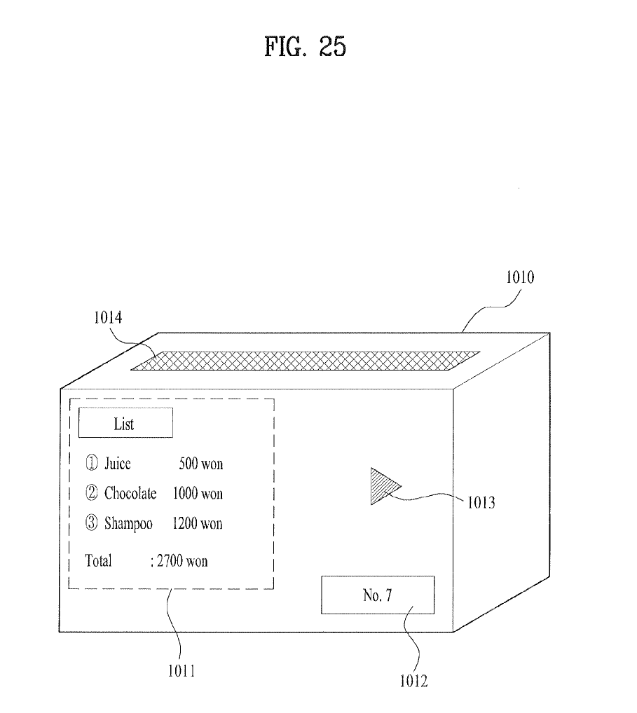

More particularly, the present invention proposes 3 different solutions for transmitting and receiving data to and from the digital device and shopping cart shown in FIG. 19. This will be described in more detail later on with reference to FIG. 20 (first embodiment), FIG. 21 and FIG. 22 (second embodiment), and FIG. 23 and FIG. 24 (third embodiment).

FIG. 20 is a detailed flow chart showing a process of a protocol for data transmission between a shopping cart and a digital device according to an embodiment of the present invention. The steps shown in shown in FIG. 20 are merely exemplary,

When a shopping cart (also referred to as a smart cart) 500 according to the embodiment of the present invention, which is located within a supermarket, approaches a digital device 510 (i.e., when the smart cart 500 comes within close range of the digital device 510), a close-range network is connected between the smart cart 500 and the digital device 510 (S501). Therefore, data may be transmitted and received between the above-described smart cart 500 and the digital device 510. As described in FIG. 19, when a random item (or product) is removed or misplaced from a specific shelf of the digital device 510, the digital device 510 transmits information on the reduced weight, which is recognized by the weight detection sensor, to the smart cart 500 (S502).

The smart cart 500 determines whether or not the random product has been recognized by the code reader (S503). Then, based upon the result of step S503, when it is determined that the random product has not been recognized by the code reader, the smart cart 500 determines whether or not the total weight of the products loaded in the smart cart 500 has increased (S507).

Then, based upon the result of step S507, when it is determined that the total weight has increased, the smart cart 500 may recognize that the corresponding random product has been improperly (or unsuccessfully) processed (S506). Step S506 will be described in more detail later on with reference to FIG. 26. However, when it is determined that the total weight has increased even though the random product has not been read by the code reader, this design of the present invention may recognize that the corresponding product has been improperly (or illegitimately) loaded in the shopping cart either intentionally or by mistake of the user.

Conversely, based upon the result of step S503, when it is determined that the random product has been recognized by the code reader, the smart cart 500 determines whether or not the information on the increased weight, which is detected by the smart cart 500, is identical to the information on the decreased weight, which is received from the digital device 510 (S504).

Thereafter, based upon the result of step S504, when it is determined that the two weights are identical to one another, the smart cart 500 may recognize that the corresponding random product has been properly (or successfully) processed (S505). However, based upon the result of step S504, when it is determined that the two weights are different from one another, the smart cart 500 may recognize that the corresponding random product has been improperly (or unsuccessfully) processed (S506). The solution according to this embodiment of the present invention corresponds to a solution used for identifying when products that are touched to the code reader by the user do not match the products that are actually loaded in the shopping cart.

FIG. 21 is a detailed flow chart showing the process of a protocol for data transmission between a shopping cart and a digital device according to another embodiment of the present invention. The steps shown in shown in FIG. 21 are merely exemplary.

As compared to the embodiment described above with reference to FIG. 20, in addition to the weight information of a specific product, the solution shown in FIG. 21 uses additional information (e.g., product ID, price information, and so on), thereby reducing the possibility of any product being illegitimately (or improperly) loaded in the shopping cart.

When a shopping cart (also referred to as a smart cart) 600 according to the embodiment of the present invention, which is located within a supermarket, approaches a digital device 610 (i.e., when the smart cart 600 comes within close range of the digital device 610), a close-range network is connected between the smart cart 600 and the digital device 610 (S601). Therefore, data may be transmitted and received between the above-described smart cart 600 and the digital device 610. As described in FIG. 19, when a random item (or product) is removed or misplaced from a specific shelf of the digital device 610, the digital device 610 transmits information on the reduced weight, which is recognized by the weight detection sensor, and additional information of the corresponding product A to the smart cart 600 (S602).

By using the additional information of product A, which is transmitted in step S602, the smart cart 600 displays a guidance message or an advertisement message on product A (S603). Therefore, the smart cart 600 may inform the user of the corresponding smart cart 600 of the products that are to be loaded in the smart cart 600. Hereinafter, step S603 will be described in detail later on with reference to FIG. 22.

The smart cart 600 determines whether or not the random product has been recognized by the code reader (S604). Then, based upon the result of step S604, when it is determined that the random product has not been recognized by the code reader, the smart cart 600 determines whether or not the total weight of the products loaded in the smart cart 600 has increased (S609).

Then, based upon the result of step S609, when it is determined that the total weight has increased, the smart cart 600 may recognize that the corresponding random product has been improperly (or unsuccessfully) processed (S608). Step S608 will be described in more detail later on with reference to FIG. 26. However, when it is determined that the total weight has increased even though the random product has not been read by the code reader, this design of the present invention may recognize that the corresponding product has been improperly (or illegitimately) loaded in the shopping cart either intentionally or by mistake of the user.

Conversely, based upon the result of step S604, when it is determined that the random product has been recognized by the code reader, the smart cart 600 determines whether or not the additional information transmitted in step S602 is identical to the information read by the code reader (S605). Subsequently, based upon the result of step S605, when it is determined that the two information are not identical to one another, the smart cart 600 may recognize that the corresponding random product has been improperly (or unsuccessfully) processed (S608). By adding the above-described step S605, this solution may prevent products having the same or similar weight from being illegitimately (or improperly) loaded in the shopping cart.

Meanwhile, based upon the result of step S605, when it is determined that the two information are identical to one another, the smart cart 600 determines whether or not the information on the increased weight, which is detected by the smart cart 600, is identical to the information on the decreased weight, which is received from the digital device 610 (S606).

Thereafter, based upon the result of step S606, when it is determined that the two weights are identical to one another, the smart cart 600 may recognize that the corresponding random product has been properly (or successfully) processed (S607). However, based upon the result of step S606, when it is determined that the two weights are different from one another, the smart cart 600 may recognize that the corresponding random product has been improperly (or unsuccessfully) processed (S608). The solution according to this embodiment of the present invention corresponds to a solution used for identifying when products that are touched to the code reader by the user do not match the products that are actually loaded in the shopping cart.

FIG. 22 illustrates an example of a user interface provided by the shopping cart shown in FIG. 21. For example, the present invention may be designed so that the user interface shown in FIG. 22 can be output in step S603 of FIG. 21.

As described above, the display device shown in FIG. 22 may be designed to be attached to the smart cart 600 shown in FIG. 21. A display device 710 that can be mounted on (or attached to) the smart cart may be designed to have a code reader 715 positioned in a specific area of the display device 710. In addition, although the code reader 715 is located in an upper portion of the display device 710 in FIG. 22, this is merely exemplary. Therefore, the scope of the present invention is not limited only to the position shown in FIG. 22.

Moreover, the display device 710 uses the additional information on product A, which is received from the digital device, thereby outputting a guidance message, which notifies the user (or customer) that product A can be loaded in the smart cart. For example, as shown in FIG. 22, the display device 710 displays an image and price information of product A in a first area 714, and the display device 710 displays a message directing the user to touch product A on the code reader in a second area 711. Additionally, for customers (or users) who do not wish to purchase product A, the display device 710 may also display a “Cancel” option in a third area 713. Moreover, in order to allow the user of the smart cart to easily select the above-described areas, the display device 710 includes a touch sensor. This has already been described above with reference to FIG. 18.

Furthermore, several tens to several hundreds of the above-described display devices 710 may be provided within the supermarket. Therefore, in order to identify each of the display devices, the scope of the present invention may also include assigning a unique identification (ID) information to each display device and displaying the assigned ID information in a fourth area 712.

FIG. 23 is a detailed flow chart showing the process of a protocol for data transmission between a shopping cart and a digital device according to yet another embodiment of the present invention. The steps shown in shown in FIG. 23 are merely exemplary.

As compared to the embodiment described above with reference to FIG. 21, FIG. 23 is advantageous in that the user is not required to touch each product to the code reader one by one. Therefore, the payment process may be accelerated and the user convenience may be enhanced.

When a shopping cart (also referred to as a smart cart) 800 according to the embodiment of the present invention, which is located within a supermarket, approaches a digital device 810 (i.e., when the smart cart 800 comes within close range of the digital device 810), a close-range network is connected between the smart cart 800 and the digital device 810 (S801). Therefore, data may be transmitted and received between the above-described smart cart 800 and the digital device 810. As described in FIG. 19, when a random item (or product) is removed or misplaced from a specific shelf of the digital device 810, the digital device 810 transmits information on the reduced weight, which is recognized by the weight detection sensor, and additional information (e.g., product ID, price information, and so on) of the corresponding product B to the smart cart 800 (S802).

By using the additional information of product B, which is transmitted in step S802, the smart cart 800 displays a guidance message or an advertisement message on product B (S803). Therefore, the smart cart 800 may inform the user of the corresponding smart cart 800 of the products that are to be loaded in the smart cart 800. Hereinafter, step S803 will be described in detail later on with reference to FIG. 24.

Moreover, the smart cart 800 determines whether or not a predetermined period of time has elapsed from the point of step S802 or from the point of step S803 (S804). Then, based upon the result of step S804, when it is determined that the predetermined period of time has elapsed, the smart cart 800 may recognize that the corresponding product has been improperly (or unsuccessfully) processed (S807). In addition, according to another embodiment of the present invention, the above-described step S804 may be deleted, and the smart cart may be controlled accordingly.

Conversely, based upon the result of step S804, when it is determined that the predetermined period of time has not elapsed, the smart cart 800 determines whether or not the information on the increased weight, which is detected by the smart cart 800, is identical to the information on the decreased weight, which is received from the digital device 810 (S805).

Thereafter, based upon the result of step S805, when it is determined that the two weights are identical to one another, the smart cart 800 may recognize that the corresponding product has been properly (or successfully) processed (S806). However, based upon the result of step S805, when it is determined that the two weights are different from one another, the smart cart 800 may recognize that the corresponding random product has been improperly (or unsuccessfully) processed (S807).

When the present invention is designed as shown in FIG. 23, the smart cart or the display device is not required to be additionally equipped with a card reader. Thus, this design of the present invention is advantageous in that the efficiency in using resource can be enhanced. Accordingly, not only the user of the smart cart but also the employees of the supermarket will no longer need to essentially use the code reader.

FIG. 24 illustrates an example of a user interface provided by the shopping cart shown in FIG. 23. Hereinafter, a user interface provided by the shopping cart shown in FIG. 23 will be described in detail with reference to FIG. 24. For example, the present invention may be designed so that the user interface shown in FIG. 24 can be output in step S803 of FIG. 23.

As described above, the display device shown in FIG. 24 may be designed to be attached to the smart cart 800 shown in FIG. 23.

A display device 910 that can be mounted on (or attached to) the smart cart may be designed to have a code reader 915 positioned in a specific area of the display device 910. In addition, when using the smart cart, which is designed in accordance with the embodiment shown in FIG. 23, the display device 910 may be designed to have a structure that does not include the code reader 915.

Moreover, the display device 910 uses the additional information on product B, which is received from the digital device, thereby outputting a guidance message, which notifies the user (or customer) that product B can be loaded in the smart cart. For example, as shown in FIG. 24, the display device 910 displays an image and price information of product B in a first area 914, and the display device 910 displays a notification message informing the user that product B may be immediately loaded in the smart cart in a second area 911. As compared to FIG. 7, the message being displayed in the second area may vary. This is because the smart cart according to this embodiment of the present invention, shown in FIG. 24, is designed to recognize product information of a specific product without having to touch the corresponding product on a code reader.

Additionally, for customers (or users) who do not wish to purchase product B, the display device 910 may also display a “Cancel” option in a third area 913. Moreover, in order to allow the user of the smart cart to easily select the above-described areas, the display device 910 includes a touch sensor. This has already been described above with reference to FIG. 18.

Furthermore, several tens to several hundreds of the above-described display devices 910 may be provided within the supermarket. Therefore, in order to identify each of the display devices, the scope of the present invention may also include assigning a unique identification (ID) information to each display device and displaying the assigned ID information in a fourth area 912.

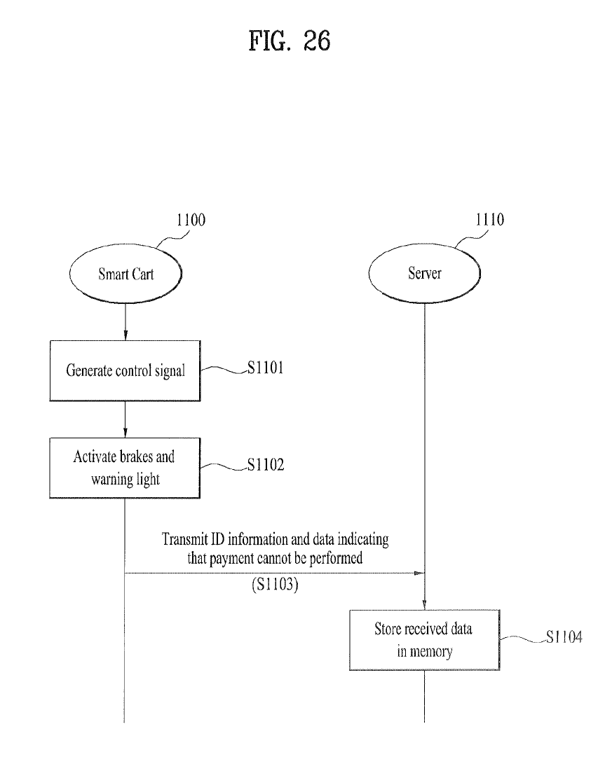

FIG. 25 illustrates an example of a user interface output from the display module shown in FIG. 18. Hereinafter, an example of the user interface outputting a display module of a display device, which can be attached to the shopping cart, will be described in detail with reference to FIG. 25.

Information on a product, which has been successfully (or properly) processed in step S505 of FIG. 20, step S607 of FIG. 21, and step S806 of FIG. 23 is stored in a memory of the display device shown in FIG. 25. Herein, the memory has already been described above with reference to FIG. 18. Accordingly, the memory of the display device shown in FIG. 25 accumulates the information on the products that have been successfully processed and stores the respective information.

As shown in FIG. 25, the display device 1010 according to the embodiment of the present invention uses the data stored in the above-described memory, so as to display a graphic showing a list of products that have been successfully processed in a first area 1011.

Meanwhile, although it is assumed in FIG. 25 that three (3) products (e.g., Juice: 500 won, Chocolate: 1,000 won, and Shampoo: 1,200 won) have been successfully process, in some cases, when there are too many successfully products, it will actually be impossible to output all of the successfully processed products in a single frame. Therefore, in order to resolve this problem, although not all of the products are currently displayed on the display screen, the scope of the present invention may also include displaying an option, which indicates that more successfully processed products exist, in a second area 1013.

Moreover, the memory of the display device 1010 stores unique ID information at a consistent address. Herein, there is no particular limitation in the unique ID information. For example, the unique ID information may be configured in the format of a specific number.

Accordingly, it will be advantageous in that each of the smart carts being equipped with the display device according to the embodiment of the present invention can be easily identified. This will be described in more detail later on with reference to FIG. 26. In addition, although it is shown in FIG. 25 that the unique ID is displayed in the third area 1013, according to another embodiment of the present invention, the unique ID may also be designed to be displayed only upon special request made by the user.

Furthermore, although it is displayed in FIG. 25 that the display device 1010 is equipped with a code reader 1014, according to another embodiment of the present invention, the scope of the present invention may also include separately equipping the smart cart with the display device and the code reader 1014.

FIG. 26 illustrates a detailed flow chart showing the process of a protocol for data transmission between a shopping cart and a server according to an embodiment of the present invention. Herein, FIG. 26 shows an solution for implementing the above-described step S506 of FIG. 20, step S608 of FIG. 21, and step S807 of FIG. 23. Therefore, it will first be assumed in FIG. 26 that a specific product has been improperly (or illegitimately) loaded in the smart cart 1100 according to the embodiment of the present invention.

The smart cart 1100 generates a control signal for processing products that have been unsuccessfully (or improperly) processed (S1101). Then, based upon the control signal generated in step S1101, the smart cart 1100 may be designed to have a visual warning light blink, so as to be visually noticed by the user. Alternatively, based upon the control signal generated in step S1101, the smart cart 1100 may also be designed to have an audible warning sound be output, so as to be audibly noticed by the user. Furthermore, the smart cart 1100 may also be designed to have brakes of the smart cart, which are included in the structure of the smart cart in order to prevent the smart cart from moving, to be mechanically operated so as to stop the smart cart from moving. In addition, among the above-described methods, the brakes and the warning light may also be designed to be activated and operated at the same time (S1102).

However, considering the complaints that may be conveyed by the user using the smart cart 1100, the scope of the present invention may also include omitting step S1102 and directly processing the payment process from step S1101 to step S1103.

The smart cart 1100 transmits ID information for identifying the corresponding smart cart or display device and also transmits data indicating that at least one or more products is/are improperly (or illegitimately) loaded in the smart cart 1100 to the server 1110 (S1103).

The server 1110 stores the ID information and data transmitted in step S1103 in the memory (S1104). When the smart cart according to the present invention is designed as described above, the smart cart corresponding to the stored ID information may be controlled so that the final payment cannot be processed.

For example, when the smart cart 1100 approaches the digital signage display in order to process the final payment, the digital signage display transmits a request signal to the server 1110. At this point, for example, the request signal may include data inquiring whether or not the final payment for the smart cart assigned with the corresponding ID information can be authorized.

In addition, in FIG. 26, it is assumed that data indicating the presence of at least one or more successfully processed products, which are loaded in the smart cart, are transmitted from the smart cart 1100 to the server 1110. However, the present invention will not be limited only to the example presented herein.

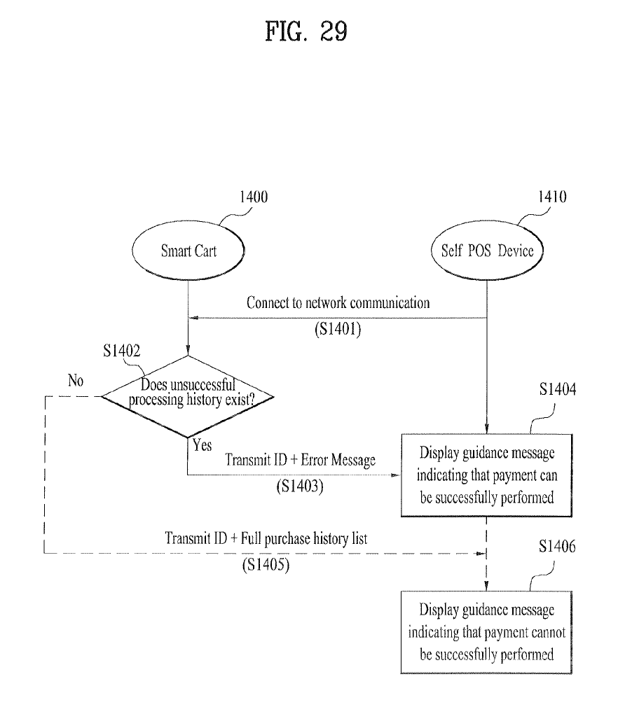

According to another embodiment of the present invention, the present invention may also be designed so that the smart cart 1100 can transmit the data indicating the presence of at least one or more successfully processed products, which are loaded in the smart cart, to the digital signage display in order to process the final payment. This will be described in more detail later with reference to FIG. 28 and FIG. 29.

FIG. 27 illustrates a process of a display device attached to a shopping cart for controlling motions of the shopping cart according to an embodiment of the present invention. More particularly, FIG. 27 corresponds to a detailed solution for implementing step S1102 shown in FIG. 26.

When successfully processed products are only loaded in the smart cart 1200 according to the embodiment of the present invention, as shown in (a) of FIG. 27, the controller of the display device 1210 maintains a wheel controller 1230 at an open state, which is connected to the display device 1210 through a wired line 1220. Herein, for example, the display device 1210 corresponds to the display device described above with reference to FIG. 17 or FIG. 18.

Meanwhile, when unsuccessfully processed products are also loaded in the smart cart 1201, as shown in (b) of FIG. 27, the smart cart 1201 generates a specific command More specifically, the controller of the display device 1211 mounted on the smart cart 1201 generates a command signal for controlling the wheel controller.

Thereafter, the command signal generated by the controller of the display device 1211 is delivered to the wheel controller 1231 through the wired line 1221. Herein, the wheel controller 1231 may also be designed to have its state shifted to a closed state. The closed state of the wheel controller 1231 refers to an angle of the wheel controller 1231 being more narrow within a predetermined range, as shown in (b) of FIG. 27, so that the wheels of the smart cart cannot move.

FIG. 28 illustrates a general view showing a communication status between a shopping cart and a digital signage according to an embodiment of the present invention. As shown in FIG. 28, it will be assumed that a smart cart 1310, which is only carrying successfully processed products or also carrying unsuccessfully processed products, approaches the digital signage display 1300. As described above, the digital signage display 1300 corresponds to a new solution that replaces the related art system processing final payment by having individual employees manipulate POS terminals. More specifically, the digital signage display corresponds to a perfectly unmanned (or unattended) system that does not require any human resource, such as employees of the supermarket.

Moreover, when the smart cart 1310 is located within a wireless network area of the digital signage display 1300, the display device 1311 equipped in the smart cart transmits a specific signal to the digital signage display 1300. Herein, for example, the specific signal may correspond to the unique ID information stored in the memory of the display device 1311. Therefore, after receiving the unique ID information, the digital signage display 1300 may display a guidance message 1301 indicating that a smart cart equipped with the specific display device has been recognized.

As described above, when the display device is designed to display the specific message 1301, the user (or customer) using the corresponding smart cart 1310 may quickly access the specific digital signage display 1300, which has recognized the corresponding smart cart 1310 among the plurality of other smart carts provided in the supermarket.

FIG. 29 illustrates a detailed flow chart showing the process of a protocol for data transmission between a shopping cart and a digital signage display according to an embodiment of the present invention. When the smart cart 1400 according to the embodiment of the present invention is located within close proximity to the digital signage display (also referred to as a self POS device) 1410, connection may be made to a wireless communication network (S1401).

At this point, the smart cart 1400 primarily determines whether or not an unsuccessfully processed history is recorded in the memory (S1402). Then, based upon the result of step S1402, when it is determined that such history exists, the smart cart 1400 transmits unique ID information identifying the corresponding smart cart 1400 or the display device equipped to the corresponding smart cart 1400 and also transmits an error message to the digital signage display (S1403). Herein, for example, the unique ID information and the error message are stored in the memory included in the display device of the smart cart 1400.

Accordingly, the digital signage display 1410 may display a message informing the user that payment cannot be successfully processed (S1404). Additionally, the scope of the present invention may also include outputting a guidance message, which indicates that re-recognition of each product should be performed by using the code reader of the smart cart, at the same time as the message displayed in step S1404.

Meanwhile, based upon the result of step S1402, when it is determined that the history of any unsuccessfully processed products does not exist, the smart cart 1400 transmits unique ID information identifying the corresponding smart cart 1400 or the display device equipped to the corresponding smart cart 1400 and also transmits a complete payment history list to the digital signage display (S1405). Herein, for example, the unique ID information and the complete payment history list are stored in the memory included in the display device of the smart cart 1400.

Accordingly, the digital signage display 1410 may display a message informing the user that payment can be successfully processed (S1406).

The smart cart according to another embodiment of the present invention may transmit information on the products purchased by the user to a database of the server in real time. Accordingly, this is advantageous in that the digital signage display, which can communicate with the server, can immediately display the payment information. Furthermore, this is also advantageous in that the supermarket may prevent in advance the forming of long waiting lines for the final payment process.

In short, the above-described method for controlling the digital signage display may be recapitulated as described below.

The digital signage display is controlled to detect a specific shopping cart that is equipped with a code reader, a memory, and a communication module and also to perform communication with the communication module of the detected specific shopping cart.

Also, the digital signage display receives first information and second information stored in the memory of the specific shopping cart. The first information corresponds to the unique ID data that are assigned in order to be identified among a plurality of other shopping carts existing in the supermarket, and the second information corresponds to the data indicating whether or not the payment process for the products loaded in the shopping cart can be processed. Moreover, when the second information indicates that the payment process for the products loaded in the shopping cart can be processed, the digital signage display displays a first message providing the user with guidance for the payment process respective to the products loaded in the corresponding shopping cart.

Additionally, when the second information indicates that the payment process for the products loaded in the shopping cart cannot be processed, the digital signage display displays a second message notifying that the payment process cannot be performed. Furthermore, according to another embodiment of the present invention, the step of displaying a second message may further include the steps of transmitting the second message to the server, and displaying a text requesting the user to re-touch the products loaded in the shopping cart to the code reader.

Meanwhile, according to yet another embodiment of the present invention, the digital signage display is designed to receive information on a list of products loaded in the shopping cart, the list being received from the communication module of the shopping cart, and to receive information on a total payment amount (or charged sum). At this point, the digital signage display primarily displays the information on the received list and the information on the total payment amount, and the digital signage display secondarily displays a message providing the user with guidance for performing the payment method.

As described above, the display device attachable to shopping carts, the shopping cart, and the digital signage according to the present invention have the following advantages. The present invention may define a communication protocol between a digital device displaying the products located in the supermarket and a display device mounted on shopping carts of a supermarket. Additionally, the present invention may also provide a digital system that can prevent products or items located (or displayed) in each aisle of the corresponding supermarket from being lost or stolen. Furthermore, the present invention may define and provide a communication method of a digital signage and a user interface that can replace the large number of employees working in the corresponding supermarket, thereby minimizing the payment process.

Furthermore, although the drawings have been distinguished and divided in order to facilitate the description of the present invention, the present invention may be designed to form a new embodiment by combining some of the above-described embodiments of the present invention. Moreover, whenever required by anyone skilled in the art, the scope of the present invention includes designing a recording medium readable by a computer, the computer having a program for executing the above-described embodiments of the present invention recorded therein.

The display device and the method for operating the same according to the present invention may not be limited only to the above-described configuration and methods according to the embodiments of the present invention. Accordingly, variations of the embodiments of the present invention may be configured by selectively combining each embodiment of the present invention fully or in part.

Meanwhile, the method of operating the display apparatus according to the present invention may be realized as a code that can be read by a processor provided in the image display device in a recording medium that can be read by a processor. The recording medium that can be read by the processor includes all types of recording devices storing data that can be read by the processor. Examples of the recording media that can be read by a processor may include ROMs, RAMs, CD-ROMs, magnetic tapes, floppy disks, optical data storing devices, and so on. Also, an recording medium being realized in the form of a carrier wave, such as a transmission via Internet, may also be included. Also, the recording medium that can be read by a processor may be scattered within a computer system, which is connected through a network. And, a code that can be read by the processor may be stored and executed by using a dispersion (or scattering) method.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents. It is also apparent that such variations of the present invention are not to be understood individually or separately from the technical scope or spirit of the present invention.

Also, a device invention and a method invention are both described in this specification of the present invention. Therefore, whenever required, the description of both inventions may be supplementarily applied.

What is claimed is:

1. A display device attachable to a shopping cart, the display device comprising:
a communication module configured to receive information on a specific product from a digital device displaying at least one or more products;
a code reader configured to read code information attached to a random product selected from the at least one or more products;
a display module; and
a controller configured to compare the code information of a product recognized by the code reader with the received information on the specific product, and to control the display module to either display a guide message that the compared code information and the received information are identical or a guide message indicating the compared code information and the received information are not identical.

2. The display device of claim 1, wherein the received information on the specific product includes at least any one of weight information of the specific product and code information of the specific product.

3. The display device of claim 2, wherein, when the received information on the specific product corresponds to the weight information, the controller is further configured to compare an added weight recognized by a weight detection sensor included on the shopping cart with the weight information of the specific product.

4. The display device of claim 1, wherein, when the compared code information and the received information are identical, the controller is further configured to store in a memory data indicating that a payment process for the specific product can be performed, and
wherein, when the compared code information and the received information are not identical, the controller is further configured to store in the memory data indicating that the payment process for the specific product cannot be performed.

5. The display device of claim 4, wherein the guide message indicating the compared code information and the received information are not identical indicates that the payment process cannot be performed.

6. The display device of claim 4, wherein, when the compared code information and the received information are not identical, the controller is further configured to generate a control signal directing wheels of the shopping cart to be locked.

7. A method for controlling a digital signage display located in a supermarket, the method comprising:
detecting a specific shopping cart equipped with a display device including a code reader, a memory, and a communication module;
performing communication between the detected specific shopping cart and the digital signage display;
receiving first information and second information stored in the memory of the display device, wherein the first information corresponds to a unique ID data assigned in order to enable the shopping cart to be identified among a plurality of other shopping carts existing in the supermarket, and wherein the second information corresponds to data indicating whether or not a payment process for products loaded in the shopping cart can be performed;
displaying a first guidance message providing a user with guidance for performing the payment process respective to the products loaded in the shopping cart, when the second information indicates that the payment process can be performed; and
displaying a second guidance message informing the user that the payment process respective to the products loaded in the shopping cart cannot be performed, when the second information indicates that the payment process cannot be performed.

8. The method of claim 7, further comprising:
receiving information on a list of products loaded in the shopping cart and information on a total payment amount from a communication module of the shopping cart.

9. The method of claim 8, wherein the displaying the first guidance message comprises:
primarily displaying the received information on the list of products and the received information on the total payment amount; and
secondarily displaying a message providing the user with guidance for performing the payment process.

10. The method of claim 7, wherein the displaying the second message comprises:
transmitting the second message to a server; and
requesting the user to re-touch the products loaded in the shopping cart to the code reader.

11. A method for controlling a server managing a plurality of devices located in a supermarket, the method comprising:
receiving information on at least one or more products from a wireless module of a display device equipped to a shopping cart, in real time, wherein the information of the at least one or more products is mapped to a first ID information for identifying a specific cart;
storing the received information on the at least one or more products in a database along with the first ID information;
receiving a request signal requesting price information corresponding to a specific shopping cart from a digital signage display, wherein the request signal includes a second ID information identifying the digital signage display;
accessing the database and calculating a total price information for the at least one or more products loaded in the shopping cart; and
transmitting the total price information to the digital signage display corresponding to the second ID information.

12. The method of claim 11, wherein the transmitting the total price information comprises:
transmitting a list including price information and image data of a first product and price information and image data of a second product, both the first product and the second product being mounted on the shopping cart.

13. The method of claim 11, wherein the shopping cart is equipped with a barcode reader and a display device.

14. The method of claim 13, wherein the receiving the information comprises:
receiving price information of a product that is read by the barcode reader attached to the shopping cart; and
receiving captured image information of a product loaded in the shopping cart without being touched and read by the barcode reader attached to the shopping cart.

15. The method of claim 11, wherein the storing the received information comprises:
categorizing the product information based upon received time information regardless of the first ID information;
collecting product information corresponding to each predetermined time region;
assigning a higher priority level to product information belonging to the time region having collected a largest amount of product information; and
storing recommended products corresponding to each time region based upon respectively assigned priority levels in a database.

16. The method of claim 15, further comprising:
monitoring a current time; and
transmitting advertisement information corresponding to a recommended product to a random digital signage display based upon the monitored current time.

17. A computer program product embodied on a computer readable medium and including instructions for controlling a server managing a plurality of devices located in a supermarket, the computer program product comprising:
a first computer code configured to receive information on at least one or more products from a wireless module of a display device equipped to a shopping cart, in real time, wherein the information of the at least one or more products is mapped to a first ID information for identifying a specific cart;
a second computer code configured to store the received information on the at least one or more products in a database along with the first ID information;
a third computer code configured to receive a request signal requesting price information corresponding to a specific shopping cart from a digital signage display, wherein the request signal includes a second ID information identifying the digital signage display;
a fourth computer code configured to access the database and calculating a total price information for the at least one or more products loaded in the shopping cart; and
a fifth computer code configured to transmit the total price information to the digital signage display corresponding to the second ID information.

18. The computer program product of claim 17, wherein the fifth computer code is further configured to transmit a list including price information and image data of a first product and price information and image data of a second product, both the first product and the second product being mounted on the shopping cart.

19. The computer program product of claim 17, wherein the shopping cart is equipped with a barcode reader and a display device.

20. The computer program product of claim 19, wherein the first computer code is further configured to receive price information of a product that is read by a barcode reader attached to the shopping cart; and
receiving captured image information of a product loaded in the shopping cart without being touched and read by the barcode reader attached to the shopping cart.
